(19) United States
(12) Patent Application Publication
(10) Pub. No.: US 2012/0298696 A1
(43) Pub. Date: Nov. 29, 2012

(54) PREDICTIVE AND ADAPTABLE PRECISION METERING DEVICE, SYSTEM AND METHOD

(75) Inventors: Thomas Kevin Milo, Cuyahoga Falls, OH (US); Peter P. Seabase, Stout, OH (US)

(73) Assignee: Failsafe Metering International Ltd., Lancashire (GB)

(21) Appl. No.: 13/480,527

(22) Filed: May 25, 2012

Related U.S. Application Data
(60) Provisional application No. 61/490,459, filed on May 26, 2011.

(51) Int. Cl. G01F 11/06

(52) U.S. Cl. 222/250

(57) ABSTRACT

A metering device and method of modular construction allows ease of set up, maintenance and process changes, without the need for changing structures and/or custom parts and without the need for special tools. The metering device monitors various operating parameters with closed loop computer feedback to enhance piston and pump control for accurate metering, to predict when routine maintenance should be performed to avoid failure, to permit automatic fine tuning of displacement during operation and to enhance production within specification tolerances while minimizing downtime. The piston cylinder assembly within the hard tooling can be readily changed to selectively have different diameter cylinders and pistons and to be readily convertible between macro and micro liquid metering. The metering device with its controls and ease of component changes allows metering systems with multiple metering devices to be easily set up with improved synchronization and accurate mixing ratios.

### RELATED APPLICATIONS

This application claims the benefit of Provisional Application No. 61/490,459, filed on May 26, 2011, entitled “Predictive and Adaptable Precision Metering Device, System and Method.” Provisional Application No. 61/490,459 is incorporated herein by reference in its entirety.

### BACKGROUND OF THE INVENTION

1. Field of the Invention

The present invention relates in general to precision metering devices for liquids and in particular to metering devices having piston cylinder assemblies dispensing the same liquid that is being used to drive the piston.

2. Description of Related Art

Metering devices dispensing the same liquid that is being used to drive the piston are well known. U.S. Pat. Nos. 6,059,148; 6,676,387; 6,886,720; and 7,017,469, which are now commonly owned by the assignee of the present patent application, disclose this type of metering device.

Of these, U.S. Pat. No. 6,059,148 discloses a piston cylinder assembly that is rotatable in a housing and includes a piston having no rods. At the beginning of operation, the piston is at the inlet end of the cylinder covering the fixed pressurized liquid inlet port and the resident liquid to be dispensed occupies the entire volume of the cylinder from the piston to the fixed liquid outlet port at the other end of the cylinder. In operation, pressurized liquid is introduced through the inlet port driving the piston to the other end of the cylinder to dispense the resident liquid through the outlet port. At the end of the piston stroke, the piston is at the other end of the cylinder adjacent the outlet port and the pressurized liquid that drove the piston resides in the cylinder between the piston and the inlet port. The piston cylinder assembly is then rotated 180° so that the piston is again positioned at the liquid inlet port and the resident liquid now extends in the cylinder between the piston and the outlet port. Thereafter, this cycle is repeated so that the inlet port and the outlet port are the same for every stroke of the piston.

In U.S. Pat. No. 6,676,387, the metering device includes a rotor having a body with a cylinder and piston therein. The rotor body further includes a first passage extending radially in one direction from the cylinder adjacent a first end of the piston to the exterior of the rotor body, and a second passage extending radially in a second opposite direction from the cylinder adjacent the second end of the piston to the exterior of the rotor body. The housing surrounding the rotor is fixed. The housing has a first set of diametrically opposed inlet and outlet passages selectively in general alignment with the first rotor passage and a second set of diametrically opposed inlet and outlet passages selectively in general alignment with the second rotor passage. The axially spaced first and second inlet passages in the housing and the axially spaced first and second outlet passages in the housing extend in diametrically opposite directions. In the first position of the rotor, the first housing inlet passage is in fluid communication with the first passage in the rotor body leading to the cylinder adjacent the first end of the piston. In such position, the second passage from the cylinder of the rotor body is in fluid communication with the second outlet passage in the housing. The second inlet passage and the first outlet passage in the housing are blocked by the exterior surface of the rotor. With such positioning, pressurized liquid introduced through the first inlet passage in the housing flows through the first passage in the rotor into the cylinder against the first end of the piston to drive the piston toward the other end of the cylinder. The liquid resident in the cylinder between the second end of the piston and the second end of the cylinder is displaced from the cylinder through the second rotor passage and the aligned second outlet housing passage. This results in the resident liquid being displaced and the pressurized liquid being contained within the cylinder between the first end of the piston and the first end of the cylinder.

The rotor is then rotated 180° to a second position. This results in the second inlet passage in the fixed housing being in fluid communication with the second passage in the rotor leading to the cylinder adjacent the second end of the piston, and the first passage in the rotor from the cylinder being in fluid communication with the first outlet passage in the housing. In such position, the first inlet passage in the housing and the second outlet passage in the housing are blocked by the rotor body. Thus pressurized liquid introduced into the second inlet passage in the housing will pass through the second passage in the rotor into the cylinder against the second end of the piston to drive the piston in the opposite direction. The piston stroke will displace the retained liquid in the cylinder through the first rotor passage and first housing outlet passage for dispensing. This process is repeated to reciprocally shuttle the piston to dispense precise metered volumes of liquid from either the first or second axially spaced housing outlet passages.

In U.S. Pat. Nos. 6,886,720 and 7,017,469, the piston cylinder assemblies have a valve assembly associated therewith. The valve assemblies are rotatable or axially slidable between two positions. In a first valve position, the pressurized liquid is introduced to the first end of the cylinder against a first end of the piston to drive that piston along the cylinder to displace the liquid between the second end of the piston and the second end of the cylinder. In a second valve position, the pressurized liquid is introduced to the second end of the cylinder against a second end of the piston to drive that piston in the opposite axial direction along the cylinder to displace the resident liquid between the first end of the piston and the first end of the cylinder. The valve is cycled between the two positions so that the pressurized liquid driving the piston in one stroke is the displaced liquid in the next stroke. The valve has passages therein that alternately cooperate with passages between the valve and cylinder to permit the pressurized liquid to alternately bear against opposite sides of the piston to reciprocate the same while also displacing the metered charge of liquid that was used to drive the piston in the previous stroke.

### BRIEF SUMMARY OF THE INVENTION

The metering device of the present invention allows easy set up and process changes without the need for changing structure or custom parts. The structural parts of the metering device may include blocks, housings or members of any construction or shape to assist in performing the liquid metering. The preferred structure consists of modular integrated blocks having cooperating passages bored therein to minimize the amount of plumbing required in the system. The integrated end blocks are easily separated to expose the piston cylinder assembly and valve assembly for routine maintenance or process changes. For example, the diameter of the cylinder and the complementary diameter of the piston can be readily changed with standardized elements. To this end, the end blocks in the tooling can have opposed annular steps at the ends thereof to selectively receive different diameter sleeves therebetween to easily change the diameter of the cylinder. The diameter of the sleeve is selected for the process and liquid to be run. Similarly, the piston is comprised of bolted together standardized parts. The standardized piston parts come in sets of different sizes. Thus, the set of standardized piston parts resulting in an outer diameter complementary to the inner diameter of the cylinder being used is selected and bolted together. The end blocks are then bolted to each end of the cylinder. The piston cylinder assembly installed for the process and liquid to be run can be easily and quickly assembled without the need for any special assembly tools or hard tooling changes.

The metering device can also be changed between macro shots or mini shots of liquid being dispensed using the same structural members. Standardized components are added or removed to easily convert back and forth as production or system changes demand. To convert from macro to mini dispensing, the end blocks are separated exposing the piston cylinder assembly. An array of needle piston sleeve inserts is positioned at each end of the cylinder in axially spaced relationship from one another. The needle piston sleeve inserts have bores running therethrough to partially receive needle piston rods removably mounted to and extending from both sides of the piston. As the piston reciprocates, the needle piston rods reciprocate in their respective sleeve insert bores to force liquid in small metered amounts to be incrementally dispensed during each piston stroke. The larger diameter size of the piston versus the amount of liquid being displaced by the smaller diameter needle piston rods allows lower liquid pressures to be employed against the piston. Needle piston sleeve insert arrays having different diameter bores or mixed diameter bores for use with needle piston rods of comparable diameter and/or a different number of sleeve inserts in the array may be selectively employed according to the process and liquid chosen to provide a range in the micro volume of liquid being precisely dispensed. To convert back to a macro metering application, the arrays of piston sleeve cartridges and needle rods are removed and the housing blocks are reattached. By having individual sleeve inserts normally arranged in an annular array, maintenance, if necessary, can be quickly performed by removing and replacing the insert or needle piston rod causing the problem. For slightly smaller or larger volume micro liquid dispensing, software adjustments can be made to slightly vary the length of the needle rod piston strokes without the need for any mechanical changes.

The metering device is also provided with numerous components to enhance cycle life and to predict the impending need for maintenance prior to failure. Several examples of these components follow with the understanding that additional components are also used that are described in the following detailed description. The standardized components of the piston are dimensioned and assembled to provide several gaps between the piston and attached piston rod. These gaps allow some relative movement for the piston and attached rod without binding or breaking during operation. The seal assembly cartridge for sealing the valve or piston rod to their respective housings has a first primary inboard seal, a second axially spaced end seal and an inert fluid cavity in between. The inert fluid cavity has a bottom filling tube and an upper outlet tube extending to a weep witness gauge. The bottom inlet tube, cavity between the seals and the top outlet tube are filled with inert fluid, with such inert fluid extending to a monitored level within a weep witness gauge. If the primary seal begins to leak, the pressurized liquid squeezing past the primary seal will engage and force the inert liquid further up into the weep witness gauge. By monitoring the change in the level within the weep witness gauge over a number of cycles, the time of primary seal failure can be predicted and routine maintenance scheduled well before failure would otherwise occur. To help protect and enhance seal life and performance, the interface between the valve and its housing is also provided with a flush return system to the reservoir for pressurized liquid in the interfaces. The flush return is spaced inboard from the seal assembly cartridge and returns liquid seeping past the matched fit between the valve body and sleeve. This flush return system keeps pressure off the primary seal of the seal assembly cartridge to enhance its life.

The metering device is also provided with a closed loop monitoring system to improve accuracy, repeatability and reliability through sensing and accurately controlling system parameters. For example, the position, direction and speed of the piston, the position, direction and speed of the valve motor, the respective inlet and outlet pressures of the pressurized liquid, and the inlet temperature of the pressurized liquid may all be continuously monitored. By continuously monitoring these and other parameters, the central microprocessor can compare the monitored data to tolerance specifications for each of these parameters to automatically make any software changes required during operation to keep these parameters and the dispensed liquid at or near their mean values and well within specified tolerances. These continuously monitored parameters and closed loop microprocessor precisely control the amount and quality of liquid being dispensed resulting in less downtime. The closed loop monitoring improves synchronization between metering devices arranged in a system to enhance the quality of the mixed product. By continuously monitoring and using the sensed parameters, the metering device can be operated with increased flexibility for varying the volume of liquid dispensed or the mix ratio, and for eliminating overrun to keep batches within the tolerances specified.

The metering device is also provided with controlled liquid circulation in or near the enclosed cylinder to avoid congealed liquid build up in the cylinder while keeping the liquid in solution. For example, the inlets to and outlets from the cylinder may have curved passages with bell mouths or a small passage system may remove stagnated pressurized liquid from the bottom of the cylinder to the reservoir.

In the accompanying drawings which are incorporated in and constitute a part of the specification, various embodiments of the invention are illustrated. These figures together with a general description of the invention given above and the detailed description given below, serve to exemplify the principles of this invention.

### BRIEF DESCRIPTION OF THE DRAWING FIGURES

FIG. 1 is a perspective view of one embodiment of a metering device illustrating its housing parts and associated motor drive for the valve;

FIG. 2 is a longitudinal cross section of the metering device of FIG. 1 showing the valve and interconnected piston cylinder metering device, with the valve in a first position and the piston shown at or near the end of its left to right stroke as viewed in this figure;

FIG. 3 is a longitudinal cross section similar to FIG. 2, except the valve body has been rotated 180° to a second position and the piston is at or near the end of its right to left stroke as viewed in this figure;

FIG. 4 is an enlarged sectional view of the right end of the valve of FIGS. 2 and 3, showing details of the seal assembly cartridge for sealing the valve body to the valve sleeve, the seal assembly cartridge containing two axially spaced seals and an inert fluid weep cavity inbetween;

FIG. 5 is a schematic view partially in section of the right side of the top and middle blocks showing the inert weep gauge system including the bottom inert fluid fill line, the inert fluid cavity between the seals, the top inert fluid delivery lines and the weep witness monitoring gauges;

FIG. 6 is a side elevation partially in longitudinal section of a second metering device embodiment where the piston has piston rods and the cylinder has a liquid recirculation system, with the valve being shown in a first position in which the piston is at or near the end of its right to left stroke as viewed in this figure;

FIG. 7 is a side elevation similar to FIG. 6 except the valve body has been rotated 180° to a second position, and the piston is at or near the end of its left to right stroke as viewed in this figure;

FIG. 8 is a schematic longitudinal sectional view of a third metering device embodiment showing a sleeve removably inserted into and sealed to the body modules to define the cylinder and having a piston and piston rod assembly inserted therein made of standardized parts to form a piston having a complementary outer diameter to the inner diameter of the cylinder sleeve;

FIG. 9 is a cross sectional enlargement of the piston and piston rod assembly of FIG. 8 showing a “floating” self centering connection of the piston rod to the piston and further showing details of the replaceable cylinder sleeve mount;

FIG. 10 is an enlarged side elevation partially in section of the right end of the left piston rod of FIG. 8 showing details of the seal assembly cartridge sealing the reciprocal piston rod to the seal cartridge body;

FIG. 11 is a schematic longitudinal sectional view similar to FIG. 8, except it shows a smaller diameter sleeve inserted in and sealed to the hard tooling to form a cylinder of smaller diameter and a piston and piston rod assembly inserted therein made of standardized parts to form a piston having a complementary outer diameter to the inner diameter of the smaller cylinder sleeve;

FIG. 12 is a side elevation of a fourth embodiment of a metering device for micro metering the liquid from the same hard tooling used to macro meter the liquid;

FIG. 12 A is a top plan view of the metering device of FIG. 12;

FIG. 13 is a partial side elevation similar to FIG. 12, but with one end cap, one retaining manifold, the top valve housing, the bottom center block and one bottom end block removed to display the array of piston sleeve inserts and corresponding array of needle piston rods received in the respective bores of the piston sleeve inserts at what would be one end of the cylinder;

FIG. 14 is a schematic side elevation partially in longitudinal section showing a valve and piston cylinder assembly with micro metering capability, with the oscillating rotary valve in a first position wherein the piston and needle piston rods are at or near the end of their right to left stroke as viewed in this figure;

FIG. 15 is a perspective view of the piston, piston rods, needle piston rods and the two opposed circumferential arrays of piston sleeve inserts respectively receiving the needle piston rods;

FIG. 16 is a schematic side elevation partially in longitudinal section similar to FIG. 14 showing the valve and piston with micro metering capability, except the oscillating rotary valve body has been rotated 180° to a second position wherein the piston and needle piston rods are at or near the end of their left to right stroke as viewed in this figure;

FIG. 17 is a schematic block drawing of a single metering device system for controlled delivery of a single liquid shot into a mixing and dispensing station;

FIG. 18 is a schematic block drawing of a metering system showing a master control panel controlling a master metering device and a slave metering device to synchronize the piston strokes in the master and slave devices to simultaneously dispense precisely controlled quantity shots of two liquids for mixing and filling a shipping container with the mixed product; and

FIG. 19 is a schematic block drawing of a metering system showing a third metering device added to the two metering device system of FIG. 18 by using a second slave control panel electrically connected to the master control panel to synchronously control a second slave metering device so that three liquids may be precisely metered, mixed and filled.

### DETAILED DESCRIPTION OF THE INVENTION

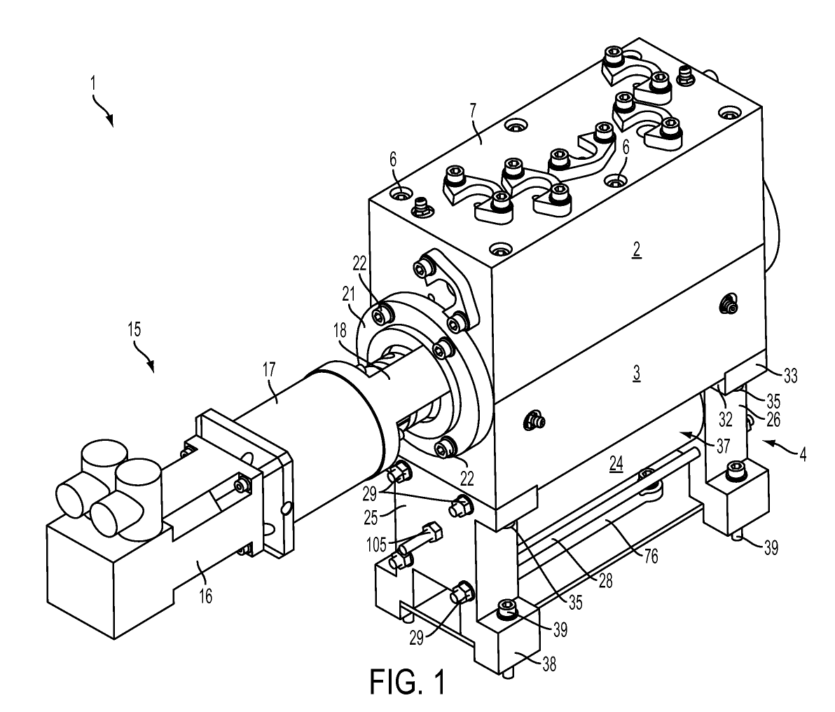

Referring now to FIG. 1, the precision metering device of the first embodiment is shown generally at 1. The metering device 1 is comprised of connected integrated modular blocks having passages bored therein selectively cooperating with one another to reduce piping and plumbing connections. The metering device 1 includes a top block 2, a middle block 3 and a base piston cylinder component, indicated generally at 4. The top block is connected to the middle block by six elongated bolts 6 vertically extending from the top wall 7 of the top block downwardly through the top block 2 into the middle block 3. The connected top and middle blocks can be secured to a wall or partition by a suitable bracket (not shown). The top and middle blocks can be easily disassembled by removing the six bolts 6 or reassembled by reinstalling the six bolts.

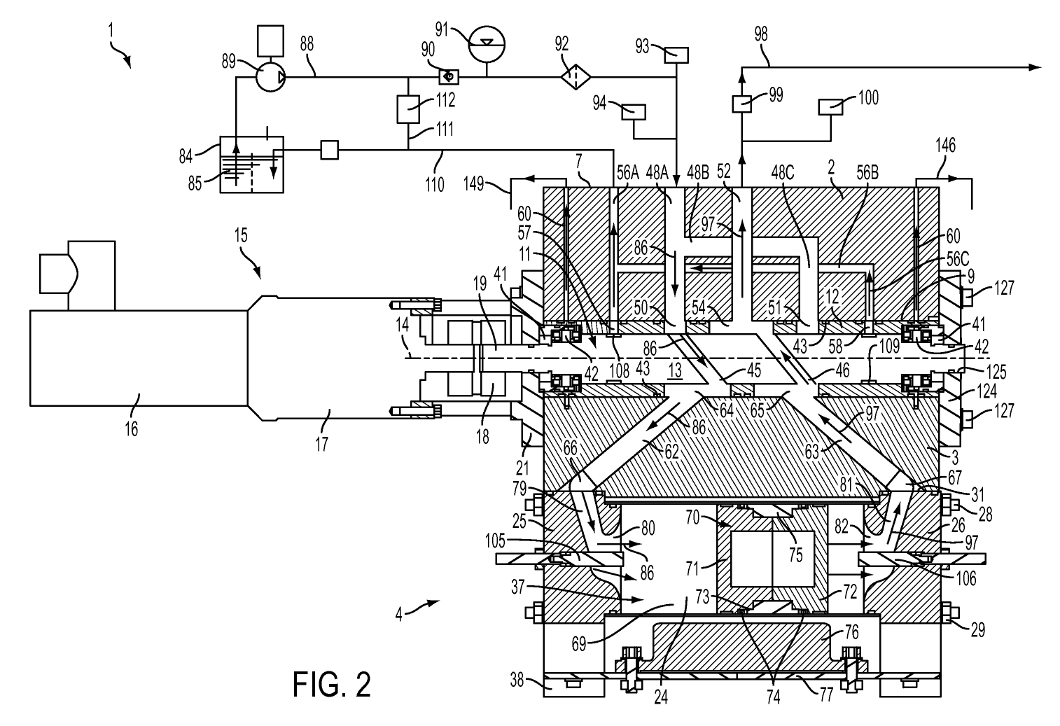

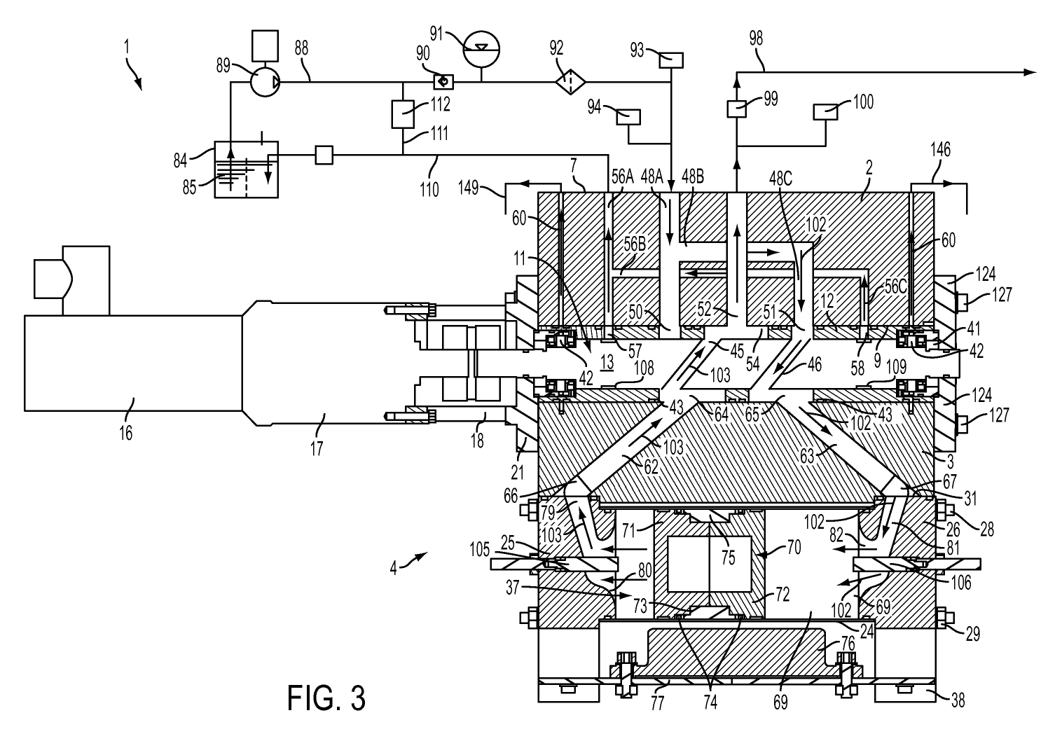

As best shown in FIGS. 2 and 3, the top and middle blocks cooperatively define a horizontally extending bore 9 passing therethrough. The top block has a downwardly facing semicircular elongated groove in its bottom surface which cooperates with an upwardly facing semicircular elongated groove in the top surface of the middle block, so that the two semicircular grooves cooperatively define the cylindrically shaped bore 9 when the top and middle blocks are connected. The bore 9 receives a valve, indicated generally at 11. The valve is preferably a rotatable valve, although an axial (linear) or other type of valve can be used in the metering device of this application. The valve 11 includes a valve sleeve 12 fixed in and sealed to the bore 9. The valve sleeve 12 has a valve body 13 received therein for rotation, and preferably for oscillatory rotation, about a longitudinal horizontal axis 14. The valve body is not shown with cross sectional lines for clarity of illustration.

A cantilevered rotary drive train, indicated generally at 15, includes a variable speed, reversible servo motor 16, gear box 17 and coupling 18. The coupling 18 connects the drive train to the coaxial drive shaft 19 extending from the end of valve body 13. The rotary drive train is removably mounted to the top and middle blocks by flange mount 21 receiving four bolts 22. The top two bolts pass through flange mount 21 into top block 2, while the bottom two bolts pass through the flange mount into middle block 3. The reversible servo motor 16 preferably oscillates the valve body through continuous cycles, each cycle including a 180° clockwise rotation followed by a 180° counterclockwise rotation as will be described in more detail below. A rotary sensor (not shown) is associated with the motor or rotating valve body to monitor the speed, position and direction of rotation. While valve body oscillation is preferred, continuous rotation of the valve body in a single direction or reciprocation linearly is also contemplated by the invention.

The top block 2 has passages bored therein selectively cooperating with top ports in valve sleeve 12 and passages through valve body 13 to deliver pressurized liquid to and from the valve 11. The middle block 3 has passages bored therein which selectively cooperate with the passages in the valve body and bottom ports in the valve sleeve to deliver pressurized liquid to and from the bottom piston cylinder assembly component 4.

The bottom piston cylinder assembly component 4 includes a cylinder 24. The two opposite ends of cylinder 24 are enclosed by left and right end blocks 25 and 26, respectively. Modular end blocks 25 and 26 are removably secured to cylinder 24 by four elongated bolts 28 having threaded ends to receive nuts 29 thereon to tightly hold the left and right end blocks in place against the ends of cylinder 24. The top and middle blocks 2 and 3 are supported on the top wall 31 of each of the end blocks 25 and 26. The top walls of the end blocks have an integrally projecting shelf 32 on each side thereof. The top wall 31 of each of the end blocks has an upwardly projecting integral skirt 33 extending across the outer periphery of the top end of the end block and partially down the sides at the outer periphery of the shelves 32. The bottom of middle block 3 is received on the top walls 31 of the end caps within the upwardly projecting skirt 33. Bolts 35 pass upwardly through the shelves 32 on the end blocks partially into the middle block to locate and secure the interconnected top and middle blocks to the left and right bottom end blocks 25 and 26.

The modular left and right end blocks 25 and 26 contain passages selectively connecting the passages in the middle block to the piston cylinder assembly, indicated generally at 37. Removal of one or both of the end blocks 25, 26 provides easy access to the piston cylinder assembly for maintenance purposes. For this purpose, the bolts 35 connecting the top and middle blocks to the end blocks are removed. The nuts 29 at one and/or both ends of the elongated end threaded bolts 28 are then removed to allow separation of one or both end blocks after releasing their respective floor connections. When the piston cylinder assembly is partially or wholly disassembled for maintenance by removing one or both end blocks, the top and middle blocks and drive train are held in place by the bracket securing them to a wall or partition. The bottoms of the end blocks are provided with feet 38 at the four corners thereof for removably securing the metering device to the floor with bolts 39. While certain connections are shown and described herein, it will be appreciated that other fasteners and connections can be used depending upon the specific metering device application.

Turning now to FIGS. 2 and 3, the side sectional elevation shows the details of valve 11 and piston cylinder assembly 37 of the first embodiment and the respective positions of the piston in two different valve positions. The valve body 13 is rotatably mounted in sleeve 12 in bore 9 by thrust bearings 41 at each end thereof, preferably to permit oscillation of the valve body 13 around longitudinal axis 14 by variable speed reversible rotary motor 16. The valve body is sealed to the sleeve by annular seal assembly cartridge 42 at each end thereof. A plurality of longitudinally spaced annular O-rings 43 along the interface between sleeve 12 and bore 9 also provide seals therebetween. The valve body 13 has two identically angled, parallel passages 45 and 46 extending therethrough. The valve passages 45 and 46 selectively cooperate with the passage systems in top block 2, depending upon the position of valve body rotation.

A liquid delivery system in top block 2 to valve 11 includes a first vertically extending main delivery passage 48A from the pressurized liquid source, a second horizontal header passage 48B and a third vertically extending delivery passage 48C longitudinally spaced from the first main vertical delivery passage 48A. The horizontal header passage 48B connects and communicates with first and third vertical liquid delivery passages 48A and 48C. At their inner ends, the vertical delivery passages 48A and 48C respectively communicate with spaced inlet ports 50 and 51 in sleeve 12.

A liquid outlet passage 52 in top block 2 extends vertically from sleeve 12 through top block 2 to top wall 7. The top portion of sleeve 12 is provided with a longitudinally elongated outlet port 54 communicating with the inner end of vertical outlet passage 52. As will be described in more detail below, the elongated outlet port 54 will communicate with one or the other of the parallel angled valve passages 45 and 46, depending upon the rotary position of valve body 13.

A flush return system in top block 2 includes first vertically extending flush passage 56A extending from the sleeve through top block 2 to top wall 7, a second horizontally extending header passage 56B and a vertically extending third main flush passage 56C extending from sleeve 12 to horizontal flush header passage 56B. The horizontally extending header passage 56B connects and communicates with vertically oriented first and third flush passages 56A and 56C. The top portion of sleeve 12 has spaced left and right flush ports 57 and 58 therein to communicate at one end with the interface between valve body 13 and sleeve 12 and at the other end with the bottoms of first and third vertical flush passages 56A and 56C, respectively.

As described in more detail below, the top block has a weep delivery passage 60 at each end thereof extending from the valve seal assembly cartridge 42 through top block 2 to the top wall 7 thereof. These weep passages 60 are part of a weep witness system with gauges to indicate whether the primary seal of the seal assembly cartridge 42 is leaking and at what rate so that routine maintenance can be scheduled before failure occurs.

The middle block 3 includes first and second passages 62 and 63, respectively, extending from sleeve 12 to left and right end blocks 25 and 26 forming part of piston cylinder assembly 37. To this end, the bottom portion of sleeve 12 has an elongated left port 64 therein, which communicates with first angled passage 62. The bottom portion of sleeve 12 also has an elongated right port 65, which communicates with second angled passage 63. The passages 62 and 63 are equally angled in opposite directions. The ports 64 and 65 communicating with the top ends of passages 62 and 63, respectively, are generally diametrically opposed to the liquid delivery and outlet passage systems in top block 2 as described above. The two oppositely angled passages 62 and 63 respectively terminate in left and right elbow passages 66 and 67. The two middle block passages alternate in delivering liquid to the piston cylinder assembly and incrementally returning a precisely metered volume of liquid from the piston cylinder assembly to valve 11.

For this purpose, the enclosed cylinder 69 of the piston cylinder assembly is cooperatively defined by the cylinder 24 and left and right end blocks 25 and 26 connected at opposite ends thereof. A piston 70 is positioned in and sealed to the bore of the enclosed cylinder 69 for controlled axial reciprocation. The piston 70 does not have piston rods mounted on opposite sides thereof to reduce the size of the metering device and to reduce the number of wear parts. The piston 70 has a left half 71 and a right half 72 removably connected together to form a hollow and thus lighter piston. The assembled piston 70 has a central peripheral annular groove 73 cooperatively defined therein containing an annular magnet 75. The magnet 75 is sealed at 74 to the piston and can be removed when the piston halves 71 and 72 are separated. The annular magnet 75 cooperates with a digital or analog elongated encoder 76 or other sensing means positioned below the cylinder 24 to continuously monitor and output a signal of the position, direction and velocity of piston 70. The encoder 76 is preferably removably mounted on a bottom shelf 77 mounted on end blocks 25 and 26.

The left end block 25 of piston cylinder assembly 37 has a passage 79 therein which is angled slightly toward the enclosed cylinder 69. The passage 79 at its upper end communicates with the bottom of elbow passage 66 in the lower portion of middle block 3. The passage 79 at its lower end has a bell mouth 80 at the entrance to enclosed cylinder 69. Similarly, the right end block 26 of piston cylinder assembly 37 has a passage 81 therein which is angled slightly toward enclosed cylinder 69. The passage 81 communicates at its upper end with elbow passage 67 in middle block 3. The passage 81 at its lower end has a bell mouth 82 at the right end entrance to enclosed cylinder 69. The passage 62, elbow passage 66, passage 79 and bell mouth 80 form a curved path to the left end of enclosed cylinder 69. Similarly, the passage 63, elbow passage 67, passage 81, and bell mouth 82 form a curved path to the right end of enclosed cylinder 69. The two curved paths including the bell mouths entering the ends of the enclosed cylinder 69 provide a controlled turning and spinning action in the liquid passing therethrough to provide sufficient turbulence to keep the liquid mixed and in solution as it enters or exits enclosed cylinder 69. Other flow paths and fluid transitions are also contemplated to obtain controlled flow and turbulence to mix the liquid without degassing, such as smoothly rounded corners or mixing blades.

Turning now to the operation of the metering device shown in FIGS. 1-3, a tank or other reservoir 84 contains the liquid 85 to be metered. This liquid may vary, for example, from thin viscosity, such as water, to medium viscosity, such as a sticky polymer, to high viscosity, such as paste. The liquid in its various viscosities is collectively referred to as material. All passages in as well as to and from the metering device are continuously filled with liquid.

In the first position of valve 11 as shown in FIG. 2, the pressurized liquid passes in incremental movements through the device to the piston cylinder assembly in the direction of arrows 86. In particular, the liquid 85 is incrementally delivered through inlet delivery line 88 by a pump 89. The pump is controlled by a closed loop processing system to incrementally deliver liquid 85 at a selected pressure and to maintain that pressure within specification tolerances throughout continuously repeated metering cycles. The delivery line 88 contains a check valve 90, an accumulator 91 to dampen pressure spikes, a filter 92, a supply liquid pressure sensor 93, and a supply liquid temperature sensor 94. Additional sensors and hardware can be added to the metering device as required by the application.

In the valve body position shown in FIG. 2, the valve passages 45 and 46 are angled top to bottom from left to right. The first main delivery passage 48A in top block 2 is in communication with sleeve port 50 and angled valve passage 45. The second horizontally extending header passage 48B and the third vertically extending delivery passage 48C are closed by valve body 13. The pressurized liquid then incrementally passes through valve passage 45, bottom sleeve port 64, first angled passage 62, elbow passage 66, left end block passage 79 and bell mouth 80 into the left end of enclosed cylinder 69. The pressurized liquid bears against the left side of piston 70 forcing it through a controlled and precise displacement stroke from left to right as viewed in FIG. 2. The stroke of piston 70 forces the liquid on the right side of the piston to be incrementally dispensed from the right end of the enclosed cylinder for metered liquid dispensing in a precise shot amounts in a controlled fashion. In this hydraulic system wherein the passages remain filled between strokes, the amount of pressurized liquid introduced into the metering device will be equal to the amount of liquid dispensed as a shot from the metering device.

As viewed in FIG. 2, the liquid forced from enclosed cylinder 69 follows an incremental displacement path, indicated generally by arrows 97. Specifically, the liquid forced from enclosed cylinder 69 is incrementally delivered from the right end of the piston in stroke displacement increments to the valve by way of bell mouth 82, right end block passage 81, elbow passage 67 and second angled passage 63 through second bottom sleeve port 65. The liquid being dispensed is then forced in movement increments through angled valve passage 46, top sleeve outlet port 54 and vertical liquid outlet passage 52. The pressurized liquid leaving the metering device incrementally passes through outlet dispensing line 98 to a mixing and dispensing station as an accurately measured shot of liquid as will be described in more detail below. A backpressure valve 99 is positioned in outlet delivery line 98 to keep back pressure above atmospheric on the liquid residing in the metering device's passages between piston strokes to keep the liquid in solution. In the preferred operation of the present invention, a piston stroke takes place approximately every half second, although this rate can be faster or slower as required by the application. A pressure sensor 100 continuously monitors the pressure of the metered liquid as it leaves top block 2.

The motor 16 is then reversed to drive the valve body 13 in the opposite rotary direction to a second position shown in FIG. 3. In such valve position, the valve passages 45 and 46 are angled top to bottom from right to left. The pressurized liquid entering the metering device for transfer to the right end of the enclosed cylinder incrementally passes along the path indicated by arrows 102 in accordance with the controlled piston displacement. Specifically, the pressurized liquid pumped into first main delivery passage 48A incrementally passes through second horizontally extending header passage 48B and third vertically extending delivery passage 48C. The bottom part of the first main delivery passage 48A is blocked or closed by valve body 13. The pressurized liquid passes through top sleeve port 51, valve body passage 46 and elongated bottom outlet port 65 in valve sleeve 12. The pressurized liquid then incrementally passes through right angled passage 63, elbow passage 67, second angled end body passage 81 and bell mouth 82 into the right end of enclosed cylinder 69. The pressurized liquid entering the right end of the enclosed cylinder bears against the right side of piston 70 and forces the piston to stroke right to left from its position in FIG. 2 to its end position in FIG. 3. The length of the stroke of the piston and resultant liquid displacement is selected for the liquid being metered and thus the piston stroke lengths may vary from liquid to liquid.

The liquid on the left side of the piston is forced in incremental movement out of the metering device following a dispensing path indicated by arrows 103. The pressurized liquid that pushes the piston through the previous stroke is the liquid that gets incrementally dispensed in the following reverse stroke of the piston. The liquid leaving the left end of enclosed cylinder 69 in FIG. 3 incrementally passes with each displacement to the left through bell mouth 80, end body passage 79, elbow passage 66 and first angled passage 62 in middle body 3. With passage 62 now communicating with elongated bottom port 64 in valve sleeve 12, the liquid incrementally passes through valve body passage 45, top valve sleeve outlet port 54, and liquid outlet passage 52. The liquid leaving the metering device incrementally passes through outlet dispensing line 98 to the mixing and dispensing station. In the filled hydraulic system, the liquid shot delivered to the mixing and delivery station equals the volume of the liquid introduced into the device for that piston stroke displacement. The pressure of the metered liquid leaving the top block 2 is continuously monitored by pressure sensor 100 and is controlled within specification tolerances by a closed loop feedback processing system.

For this purpose, the continuously monitored parameters of the system including temperature and pressure of the pumped inlet liquid, the position, direction and speed of the piston, the speed, position and direction of the motor, and the outlet pressure of the metered liquid are inputted into a closed loop control system including a central microprocessor or programmable logic controller (PLC) in a master control panel. The master control panel is continuously comparing the inputted monitored data to the respective specifications to make sure the monitored parameters are within acceptable tolerances. If the data for any parameter begins to move away from the mean value and toward a specification tolerance limit, the microprocessor will automatically make software adjustments during operation to change piston speed and/or pump pressure as needed to stay within all parameter tolerances, thereby to reliably and accurately meter liquid meeting specifications. The closed loop feedback allows liquid displacement to be easily tuned and varied to process liquids with different characteristics to obtain accurate dispensing and mixing ratios. This quality and accuracy is maintained while taking steps to prolong the service life of the components of the metering device.

To this end, the piston is controlled to avoid abrupt starts and stops and to eliminate hard stops. In the present metering device, the motor 16 is controlled so that the valve body initially slowly uncovers the valve sleeve ports. This results in the valve body passages slowly opening so that piston 70 slowly accelerates into its stroke to avoid an abrupt start. Then the rotary valve speed increases to increase the speed of the opening of the valve body passages and the piston is moving at a constantly faster speed. When the passages and ports are open to the extent needed for the liquid being processed for a particular application, the direction of the motor is reversed at initially the same speed to maintain the speed of the piston. As the valve body passages in the reverse rotation of the valve body approach the ends of the sleeve ports, the speed of valve body rotation again is progressively slowed down to progressively close the valve passages to slow down the piston until it comes to a stop at the precisely selected position along the cylinder when all ports are closed by the rotating valve body covering them. This oscillation avoids abrupt piston starts and stops, minimizes pressure spikes, avoids overruns, and prolongs the life of the valve and piston seals. After the ports and valve passages are all closed, the speed of the valve body rotation with its passages filled with liquid is again increased to reach the next piston stroke as quickly as possible. For the next stroke, the valve finishes its higher speed reversal transition when the closed valve body passages approach the closed valve sleeve ports so as to repeat the progressively phased opening and closing of the valve ports and passages in the next stroke. By oscillating the valve, additional control is achieved and the life of the piston and valve is enhanced. A first adjustable stop 105 is positioned in the left end block 25 of the enclosed cylinder 69, and a second adjustable stop 106 is positioned in the right end block 26 of the enclosed cylinder. The stops are provided to act as fail safe hard limits to piston movement in either direction should a malfunction occur in the motor or pump. If either stop is engaged, a signal will be sent to the master control panel to immediately turn off the metering device.

Prolonging the life of the components and minimizing downtime is also accomplished through the sealing system used. The valve sealing system in FIGS. 2 and 3 includes O-ring seals 43 longitudinally spaced along and sealing the valve sleeve 12 to the bore 9 in top and middle blocks 2 and 3 of the metering device 1. The valve sealing system further includes the flush return system 56A through 56C and seal assembly cartridges 42 at each end of valve body 13.

Turning first to the flush return system, pressurized liquid may tend to migrate in both longitudinal directions along and around the interface between the oscillating valve body 13 and sleeve 12. The valve body 13 has two annular longitudinally spaced left and right grooves 108 and 109 in its outer surface aligned with two longitudinally spaced left and right flush ports 57 and 58 in the valve sleeve. The outer ends of flush ports 57 and 58 communicate with left and right vertical flush passages 56A and 56C, respectively. The pressurized liquid collected by left annular groove 108 passes through flush port 57, and vertical flush passage 56A to the top surface 7 of upper body 2. Similarly, pressurized liquid collected by right annular groove 109 passes through right flush port 58, vertical flush passage 56C, horizontal header flush passage 56B and vertical flush passage 56A. The pressurized liquid from flush header passage 56B joins with the pressurized liquid moving vertically upwardly in flush passage 56A to exit the top wall 7 of the metering device into the flush return line 110 leading to reservoir 84. The flush return system is operative to divert pressurized liquid migrating along the interface between the valve body and sleeve from reaching the end seal assembly cartridges 42.

A relief bypass line 111 extends between delivery line 88 and flush return line 110. A relief valve 112 is positioned in relief bypass line 111. The relief valve 112 is opened in the event the pump is running too fast to return over pressurized liquid to the reservoir to protect the metering device from damage. The amount of pressurized liquid returning to the reservoir through the flush return system is sensed and monitored for predictive reasons discussed in more detail below.

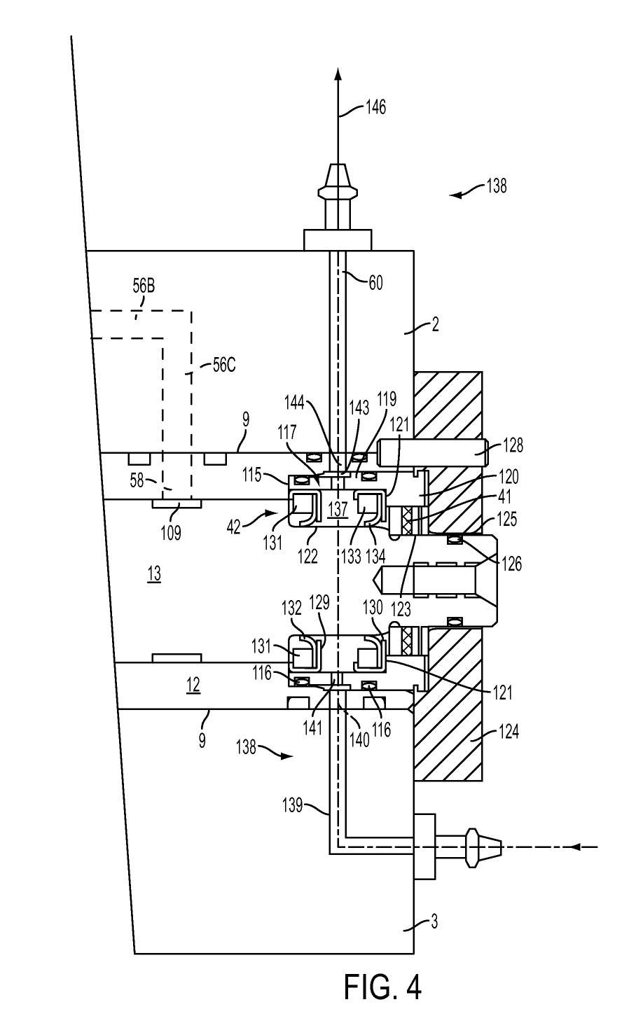

Turning now to FIG. 4, the right annular seal assembly cartridge 42 between the valve body 13 and sleeve 9 is enlarged showing its cooperation with the flush return system and weep witness gauge system. Cross sectional lines have been eliminated for clarity of illustration. The seal assembly cartridge 42 is press fit or otherwise securely received in a longitudinally extending annular recess 115 in the end of sleeve 9. The seal assembly cartridge is sealed to the sleeve by longitudinally spaced O-ring seals 116. The seal assembly cartridge 42 includes a body, indicated generally at 117 having a longitudinally extending portion 119 and a radially inwardly extending end portion 120 forming an annular shoulder 121. As will be seen in FIG. 4, the end of valve body 13 has a first radially inward, longitudinal annular step 122 to receive the seal assembly 42 and a second radially inward, longitudinal step 123 to receive the thrust bearing assembly 41. The bearing assembly 41 is mounted between the inner diameter of the end portion 120 and the second radially inward, longitudinal annular step 123 of valve body 13. The end of the bore is enclosed by an end cover plate 124 secured to the top and middle blocks 2 and 3 by removable fasteners 127. End cover plate 124 has a hole 125 that receives the end of the valve body 13. Annular O-ring seal 126 seals the valve body to the cover plate 124. An index pin 128 passes through cover plate 124 into a slot in the sleeve 9 to properly position the sleeve and its bores and to preclude any sleeve rotation. End cover plate 124 retains the seal assembly cartridge 42 and bearing assembly 41 in their proper positions along steps 122 and 123 at the end of the valve body and precludes the infiltration of dirt or other contaminants.

The seal assembly cartridge 42 includes two longitudinally spaced annular left and right seal mounting brackets 129 and 130. Left seal mounting bracket 129 captures an annular seal biasing block 131 and the first inboard primary annular lip seal 132. The biasing block 131 radially inwardly urges the annular primary lip seal 132 into sliding sealing engagement with the oscillating rotary valve body 13. The right seal mounting bracket 130 captures the right seal biasing block 133 and the right secondary annular lip seal 134. The biasing block 133 radially inwardly urges the secondary annular lip seal 134 into sliding sealing engagement with the oscillating rotary valve body 13. An annular inert liquid annular weep cavity 137 is formed between the primary seal 132 and the secondary lip seal 134 and around valve body 13. The inert liquid cavity 137 is part of the inert weep witness gauge monitoring system.

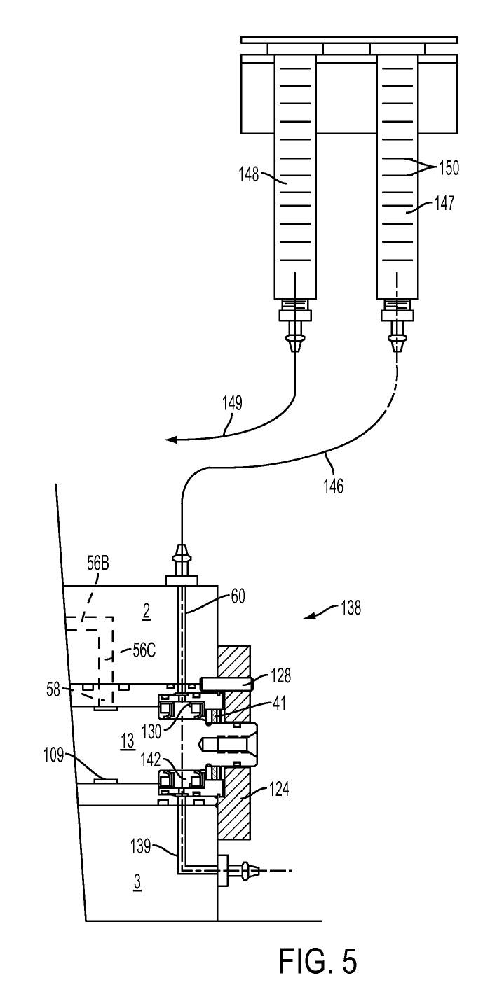

As best shown in FIGS. 4 and 5, the weep witness gauge monitoring system, indicated generally at 138, includes an inert liquid fill passage 139 in middle block 3. Inert liquids, including, by way of example only, a non reactive polymer or water, are chosen for compatibility with the liquid then being processed in the metering device. The fill passage communicates with a bottom sleeve inlet passage 140 and a seal body inlet passage 141 leading to the annular inert liquid weep cavity 137 between lip seals 132 and 134. The inert fill liquid passing around valve body 13 in annular weep cavity 137 passes upwardly through seal body outlet passage 143 and top sleeve outlet passage 144. The inert liquid then passes upwardly through weep witness outlet passage 60 in upper block 2 to and through external transfer line 146. The inert liquid transfer line 146 communicates with the bottom of weep witness monitoring gauge 147. The fill passage 139, bottom sleeve inlet passage 140, seal body inlet passage 141, annular weep cavity 137, seal body outlet passage 143, top sleeve outlet passage 144, weep witness outlet passage 60 and external inert liquid transfer line 146 are full of inert liquid. The inert liquid weep witness system is filled from the bottom to the top to avoid having any entrained air or gas in the inert liquid. The inert liquid extends into weep witness monitoring gauge 147 to a starting reference level. The weep witness gauge is provided with a scale 150 to visually monitor the level of inert liquid in the weep witness gauge and/or electronic sensors can be used for continuously monitoring the level.

The second weep monitoring gauge 148 is filled to the desired reference level by second external inert liquid transfer line 149 extending from the weep witness monitoring system at the other end of the valve. The two weep witness gauges 147 and 148 are positioned together for ease of visual monitoring. If multiple metering devices are used in a system, all the weep witness gauges for the system can be positioned adjacent one another for ease of monitoring.

As shown in FIG. 4, the annular groove 109 of the flush return system is upstream of or to the left of the primary seal 132. Any pressurized liquid migrating along the interface between the valve body 13 and sleeve 12 toward seal assembly cartridge 42 is captured and removed by groove 109, flush port 58 in sleeve 12, flush passages 56C, 56B and 56A in top body 2, and flush return line 110 to reservoir 84. By utilizing the flush return system to bleed off any pressurized liquid migrating to the right along the interface of the valve body and inner diameter of the valve sleeve, the primary seal 132 of the right seal assembly 42 is isolated to the extent possible from contact with and the pressure of any migrating pressurized liquid.

Similarly, any pressurized liquid migrating to the left along that interface is caught by the annular groove 108, flush port 57 in the sleeve, vertical flush passage 56A in the top body 2 and flush return line 110 to reservoir 84. This portion of the flush system protects the primary seal in the left seal assembly cartridge. Over the course of many, many cycles, some of the migrating pressurized liquid may get past the flush return system and impinge upon the primary seal 132 in the right or left seal assembly cartridge. Eventually, the pressurized liquid may seep past the primary seal and engage the inert liquid in cavity 137. The pressurized liquid forces the inert liquid upward in its only degree of freedom to rise in the weep witness monitoring gauge 147 and/or 148. The frequency and amount of inert liquid rise in the weep witness gauges are continuously monitored and compared to specifications allowing a prediction to be made as to how many more cycles may be run before the potential of seal failure exists in the left or right seal cartridge. This predictive capacity allows normal maintenance to be scheduled on either or both of the seal assembly cartridges before any failure occurs.

This routine maintenance is easily performed. The end cover plate 124 is removed, the bearing 41 is removed and the seal assembly cartridge 42 is removed as a module. A replacement seal assembly cartridge is then press fit into position, the bearing 41 reinstalled and the cover plate reattached. If necessary, the elongated bolts 6 connecting the top block to the middle block are removed. Then the top bolts 22 on the flange mounts 21 may be removed to allow the top block 2 to be lifted to make it easier to remove and replace the thrust bearings or seal assembly cartridges. When maintenance is complete, the top block is lowered into position on the middle block and the elongated bolts 6 and top flange mount bolts 22 reinstalled.

The back flush system enhances the life of the primary seal by minimizing the amount of pressurized liquid impinging on the primary seal and reducing the pressure on the primary seal. The weep witness gauge monitoring system permits the timely scheduling of routine maintenance to be performed before failure occurs. These features allow longer life for the parts and replacement before failure to permit extended production with minimized downtime.

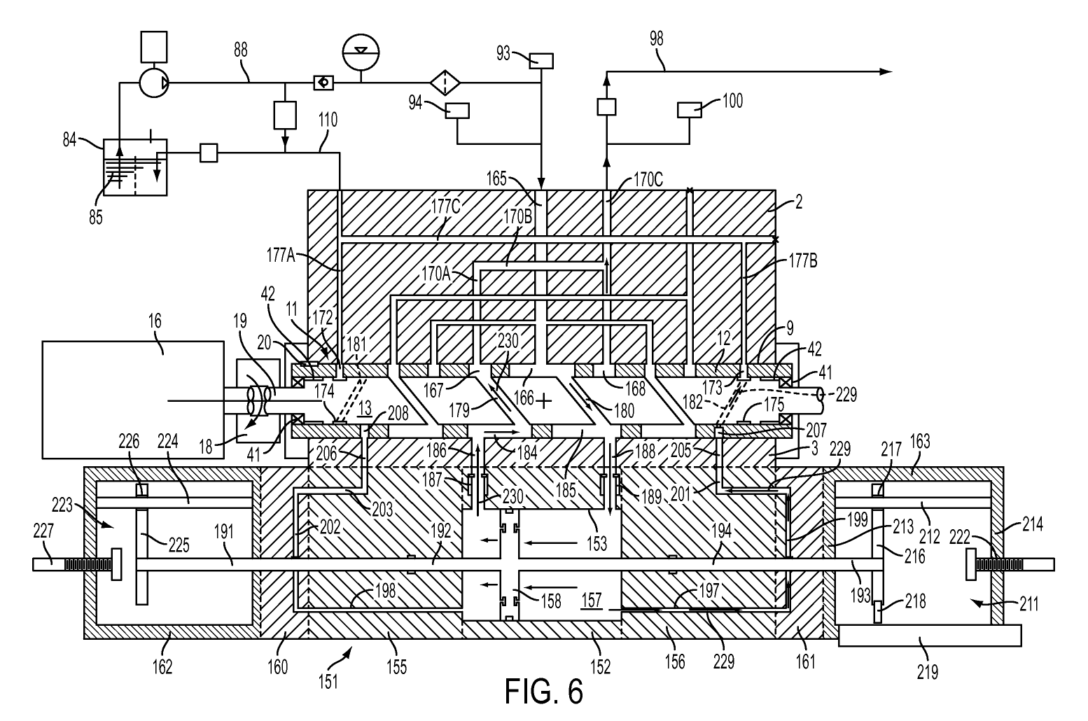

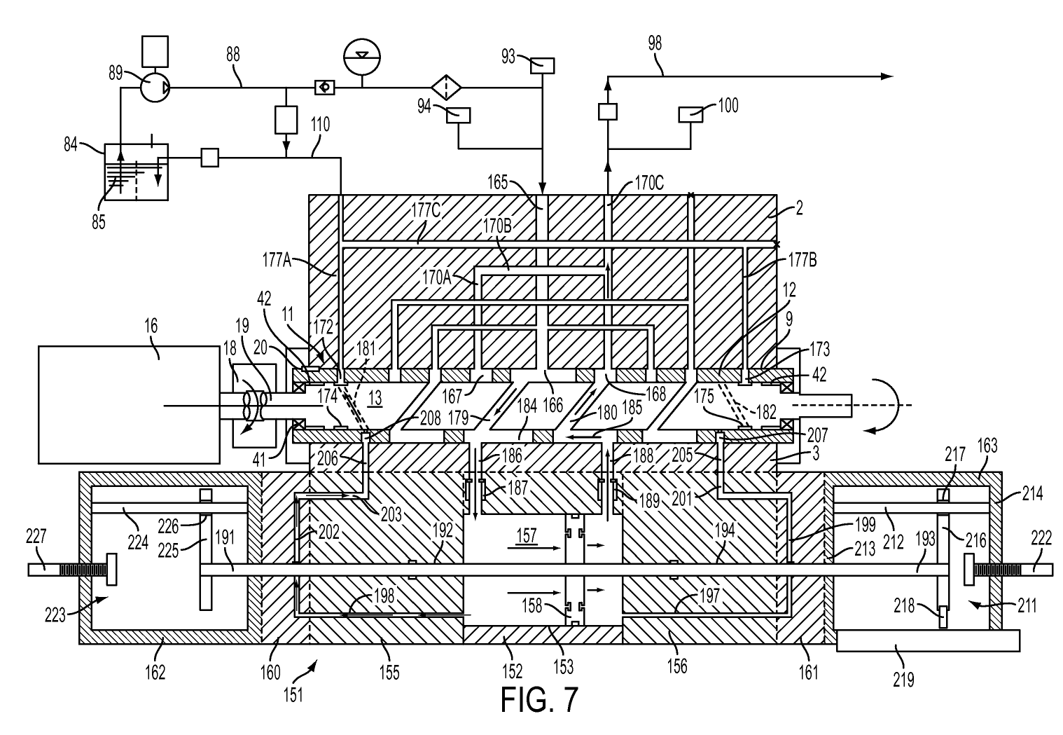

The second embodiment shown in FIGS. 6 and 7 has a top and middle block 2 and 3, respectively, cooperatively forming a bore 9 for receipt of the valve, indicated generally at 11. The valve includes a ported sleeve 12 and a rotatable valve body 13 in the sleeve. The sleeve is press fit into or otherwise secured to the bore and is fixed in place. The valve body sleeve 12 is properly positioned in the bore by an index pin 20 that aligns the sleeve ports with the passages in the top and middle blocks and selectively with the passages in the rotating valve body.

The top block 2 has passages selectively cooperating with and delivering pressurized liquid to and from the valve 11. The middle block 3 has passages extending from the bottom of the valve to the bottom block assembly, indicated generally at 151. The top and middle blocks are mounted on and removably connected to the bottom block assembly by elongated bolts extending through the top and middle blocks into the bottom block assembly. The bottom block assembly includes the piston cylinder assembly and related passages.

Specifically, the bottom block assembly includes a central block 152 containing a bored cylinder 153 passing horizontally therethrough The central block 152 is sandwiched between left and right bottom end blocks 155 and 156. These end blocks cooperate with cylinder 153 to define enclosed cylinder 157 having piston 158 mounted therein for axial reciprocation. The outer end of left bottom end block 155 has a left retaining manifold 160, and the outer end of right bottom end block 156 has a right retaining manifold 161. Elongated left bolts pass through the left retaining manifold 160, left bottom end block 155 and into the central block 152 to removably connect those parts together. Similarly, elongated right bolts pass through right retaining manifold 161 and right bottom end block 156 into central block 153 to removably connect those parts together. Left and right end caps 162 and 163 are removably connected by bolts to the left and right retaining manifolds. The bottom block assembly 151 has passages therein cooperating with the passages in the middle block to alternate delivery and dispensing of pressurized liquid to and from the enclosed cylinder 157 on opposite sides of piston 158.

The second embodiment has a number of parts that are the same as the first embodiment and are identified by common reference numerals. The top block 2 of the metering device includes a vertically extending liquid inlet passage 165 terminating at and in communication with an elongate inlet port 166 in the top portion of valve sleeve 12. As in the first embodiment, the valve sleeve 12 is received and fixed in bore 9 cooperatively defined by the top and middle modular blocks. The top block also contains a liquid outlet passage system. Such system includes a left outlet port 167 and a longitudinally spaced right outlet port 168 in the top of valve sleeve 12. The left outlet port 167 communicates with a vertically extending first outlet passage 170A in communication with horizontal header outlet passage 170B. The header outlet passage 170B communicates with a second vertically extending right outlet passage 170C. The passage 170C communicates at its inner end with the right sleeve port 168. The passage 170C communicates at its outer end with the delivery line 98 to a mixing and dispensing station.

The metering device of this embodiment also includes a flush system. The flush system includes a left flush port 172 and a longitudinally spaced right flush port 173 in sleeve 12. The inner end of left flush port 172 communicates with left annular flush groove 174 in the outer periphery of valve body 13. The inner end of right flush port 173 communicates with a right annular flush groove 175 in the outer periphery of valve body 13. The left flush port 172 at its upper end communicates with a first vertical flush outlet passage 177A that passes upwardly through upper block 2. The top end of vertical flush outlet passage 177A is coupled to the flush delivery line 110 to reservoir 84. The flush outlet system further includes a second vertical and outwardly extending flush passage 177B communicating at its inner end with the right flush port 173 in sleeve 12. The second vertical flush passage 177B communicates with a horizontal header passage 177C connected to and communicating with the first vertical flush outlet passage 177A. The flush system of this second embodiment captures pressurized liquid seeping along the interface between the valve body and sleeve to return the captured liquid to the reservoir while protecting the seal assembly cartridges 42 as described above. The flush system of this second embodiment also assists in circulating liquid in the enclosed cylinder 157 as will be described in more detail below.

The valve body 13 is mounted on thrust bearings 41 at each end of sleeve 12 to allow the valve body to rotate or preferably oscillate in a sliding and sealed interface fit with the sleeve. The valve body has a first angled passage 179 and a second parallel angled passage 180 passing therethrough. The valve body 13 further includes a first angled flush passage 181 and a second longitudinally spaced angled flush passage 182, which are parallel to one another. The two flush passages 181 and 182 are oppositely inclined with respect to parallel valve passages 179 and 180. Generally diametrically opposite top ports 166, 167 and 168, the bottom portion of valve sleeve 12 has a first elongated port 184 and a second longitudinally spaced elongated port 185. As viewed in FIGS. 6 and 7, the left end of longitudinally extending port 184 communicates with a vertically downwardly extending passage 186. Passage 186 extends through the middle block 3 and the top of the central bottom block 152. The bottom end of vertical passage 186 enters the left top end of enclosed cylinder 157 in the bottom block assembly 151. A quill 187 is positioned along vertical passage 186 and is sealed thereto. The quill 187 allows slight relative movement in the components of passage 186 to retain alignment between the portions thereof in the middle and bottom blocks. The right end of elongated port 185 in sleeve 12 communicates with a second downwardly extending vertical passage 188, which extends through the middle block and the top of central bottom block 152. The bottom end of passage 188 opens into the right top end of enclosed cylinder 157. A second quill 189 is positioned in second passage 188 to maintain alignment between the portions thereof in the modular middle and central bottom blocks.

The enclosed cylinder 157 has a piston 158 in sealed sliding contact with the internal wall of enclosed cylinder 157 for axial reciprocation therein. The piston 158 has a left piston rod 191 connected thereto and extending axially to the left thereof. Piston rod 191 is reciprocally slidingly received in and sealed to a horizontal bore 192 extending through left end block 155, left retaining manifold 160 and partially into left end cap 162. The piston 158 has a right piston rod 193 connected thereto on its other side and extending axially to the right thereof. Second piston rod 193 is reciprocally slidingly received in and sealed to a right horizontal bore 194 extending through the right end bottom block 156, right retaining manifold 161 and partially into right end cap 163.

Enclosed cylinder 157 has a first horizontal longitudinal flush passage 197 extending from the lower right hand side of the enclosed cylinder through the right end bottom block 156. Enclosed cylinder 157 has a second horizontal longitudinal flush passage 198 extending from the lower left hand side of the enclosed cylinder through the left end bottom block 155. The two bottom horizontal flush passages 197 and 198 are in general axial alignment with one another. The right retaining manifold 161 has a U-shape passage 199 passing therethrough and communicating at its bottom end with flush line 197 and communicating at its upper end with an L-shape flush line 201 in the upper right hand portion of the right end bottom block 156. The left retaining manifold 160 has a U-shape passage 202 extending therethrough and communicating at its bottom end with flush line 198 and communicating at its upper end with an L-shape flush line 203 in the upper left hand portion of the left end bottom modular block 155. The oppositely facing L-shape passages 201 and 203 in the right and left end bottom blocks communicate respectively at their upper ends with vertically extending passages 205 and 206 in the lower portion of middle block 3. The upper end of the passage 205 communicates with a right flush port 207 in the bottom of valve sleeve 12. The upper end of vertical passage 206 communicates with a left flush port 208 in the bottom of valve sleeve 12.

The right end cap 163 is surrounded by a housing having a shape to provide uncovered access to the elongated bolts removably connecting the right retaining manifold, the right bottom end block and the center block. The right end cap 163 includes a hollow framed cage 211 connected to the retaining manifold 161. A horizontal top guide rod 212 extends between and is mounted to the left and right vertical frame members 213 and 214, respectively. A vertical monitoring member 216 has a hole 217 at its upper end that receives guide rod 212. The vertical monitoring member reciprocally slides along guide rod 212. The right piston rod 193 is connected at its outer terminal end to vertical monitoring member 216. As the piston 158 reciprocates in enclosed cylinder 157, right piston rod 193 will drive the monitoring member 216 through an identical reciprocation of equal magnitudes. A magnet 218 is mounted on the bottom of the vertical monitoring member 216. The magnet 218 operationally cooperates with an elongated encoder 219 or other sensing device positioned below the framed cage 211. Encoder 219 continuously detects the position of magnet 218, which results in the position, direction and speed of piston 158 being continuously monitored. The right vertical frame member 214 has a bolt 222 threaded therethrough for longitudinal adjustment. The head of bolt 222 acts as a hard piston stop should some operational problem cause the piston 158 to overrun its intended stopping point. The piston engaging the hard stop provided by the head of bolt 222 will send a signal to shut down the system in a fail safe mode. The vertical monitoring member rigidifies the end of piston rod 193 to minimize the possibility of bending or damage if the hard stop is engaged. The connection between the end of piston rod 193 and the vertical monitoring member 216 further precludes rotation of the piston rod and piston during operation.

The left end cap 162, surrounded by a housing, is hollow and removably mounted to the left side of the left retaining manifold 160. The left end cap 162 is generally a mirror image of the right end cap 163, except the cooperation between the movable magnet and elongated encoder is only needed on one side. The left framework cage, indicated generally at 223, extends to the left from left retaining manifold. Cage 223 has a horizontal top guide rod 224 mounted thereon. A vertical stabilizing member 225 has a top hole 226 which receives the guide rod 224 for reciprocal movement therealong. The vertical stabilizing member 225 is connected to the end of left piston rod 191 to preclude rotation of the piston rod and piston and to provide extra stability. As the left piston rod 191 is reciprocally driven by piston 158, the vertical stabilizing member 225 connected at its lower end to the left end of second piston rod 191 will likewise be reciprocally driven. The left tubular cage 223 also has a left adjustable fail safe hard stop connected thereto in the form of the head of an adjustable threaded bolt 227. The right and left adjustable fail safe hard stops 222 and 227 for the piston are in axial alignment with the piston rods 193 and 191, respectively.

In operation, the valve body 13 is rotatable in and has a sliding sealed interface with the inner diameter of the sleeve 12. The valve body is rotatably driven by a variable speed, reversible servo motor 16. The output shaft of motor 16 is connected to the coaxial drive shaft 19 at one end of valve body 13 by a coupling 18. The servo motor rotates the valve body between first and second positions with a rotation of approximately 180° between the two positions. The motor 16 preferably oscillates to rotate the valve body 180° in one direction and then reverses and rotates the valve body 180° in the opposite direction of rotation. The speed and direction of rotation of the motor or valve body is continuously monitored to obtain speed, position and direction of rotation. The first valve position is shown in FIG. 6, and the second valve position is shown in FIG. 7. This valve body rotation results in all of the angular valve body passages extending in an opposite angular orientation as is apparent from comparing FIG. 6 to FIG. 7. It will be appreciated that the full 180° rotation of the valve body in both oscillating directions may not be necessary for certain liquids being dispensed and/or for certain magnitudes of pressure. The speed of motor rotation can be coordinated with the amount of valve body passage and port opening required to dispense the appropriate amount of liquid. Controlling the speed and extent of rotation of the valve body to control the extent and timing of valve passage and port opening also contributes to synchronizing multiple metering devices simultaneously used in a system to mix more than one liquid.

The speed of valve body rotation can also be varied. For example, in going from the fully open valve body position of FIG. 6 to the valve body of position of FIG. 7, the motor 16 may initially start at a faster speed to begin closing the ports and valve body passages. The motor speed and valve body rotation is then progressively slowed to finally close the ports and valve passages. This results in the piston being progressively slowed before instantly stopping at the desired location when all ports close to avoid any overrun. This avoids abrupt stops of the piston, eliminates any “hammering” effect, reduces pressure spikes and enhances piston and valve life. Once the ports are closed, the motor 16 can speed up in transition until just before the rotating valve body passages begin to uncover the opposite ports to initiate liquid flow in accordance with the arrangement of FIG. 7. The motor speed is then slowed and progressively increased as the valve passages and ports begin opening to initiate piston movement at slower but progressively increasing speeds. The motor speeds are then increased to and maintained at a relatively constant speed until the valve ports and passages are open to the extent required for the passage of the specific liquid. The motor 16 can then be reversed at the higher speed so that the passages and ports in the FIG. 7 position begin closing. The motor toward the end of port closing is then progressively slowed down until the ports and passages are closed so that the piston progressively slows to accurately stop at the selected position. By controlling motor speed and oscillating the valve body as viewed in FIGS. 6 and 7, the piston starts slowly, speeds up and then stops slowly thereby to avoid abrupt piston starts and stops. This continuing oscillation of the valve body at variable speeds allows for slower speed piston starts and stops and for increased piston speeds during the stroke and for faster valve body movement between the two valve body positions. The faster speeds of valve body movement in transition between its two positions allows for quicker cycling. The valve body oscillations at variable speeds thus increase piston and seal life by eliminating any hammering effect and also enhance productivity by cycling faster.

Turning now to the operation of the metering device shown in FIGS. 6 and 7 and initially referring to FIG. 6, liquid 85 from reservoir 84 is incrementally pumped at higher pressures through a delivery line 88 to upper block 2. The pressure and temperature of the pressurized liquid are continuously respectively monitored by pressure sensor 93 and temperature sensor 94. The pressurized liquid incrementally passing through the delivery line enters upper block 2 and incrementally passes through the vertically extending liquid inlet passage 165. The pressurized liquid then sequentially passes in incremental movements through top port 166 in valve sleeve 12, angular valve body passage 180, bottom port 185 in valve sleeve 12 and vertically extending passage 188 to enter the right top side of the enclosed cylinder 157 to drive the piston to the left as viewed in FIG. 6. A small amount of pressurized liquid exits from enclosed cylinder 157 through the flush line system to provide some controlled liquid turbulence in the enclosed cylinder. Pressurized liquid withdrawal from the enclosed cylinder 157 through the flush line system avoids any coagulation or build up of stagnated liquid in the enclosed cylinder, while keeping the liquid in solution. The pressurized liquid being removed from the cylinder incrementally follows along the path indicated generally by arrows 229. Specifically, the pressurized liquid exiting the enclosed cylinder through the flush line system passes in incremental movements sequentially through flush passages 197, 199, 201, 205, bottom sleeve port 207, valve flush passage 182, top sleeve port 173, and flush passages 177B, 177C, and 177A. The flushed liquid exiting the upper housing 2 passes through the return line 110 to the liquid reservoir 84.

As the piston 158 strokes to the left as viewed in FIG. 6, the liquid to the left of the piston gets forced from the cylinder and follows in incremental movements the path indicated by the arrows 230 in accordance with piston displacement for each stroke. Specifically, the dispensed metered liquid sequentially and incrementally passes through passage 186, elongated bottom sleeve port 184, valve body passage 179, top sleeve port 167, vertical passage 170A, longitudinal horizontal passage 170B and vertical passage 170C. Liquid leaving the upper block 2 then incrementally passes through metering delivery line 98 to a metered liquid mixing and dispensing station. An accurate metered shot of liquid from the left side of the piston is delivered from the device. The pressure of the metered liquid leaving the upper block is continuously monitored by pressure sensor 100. In the hydraulic system of the metering device wherein the passages remained filled, the volume of pressurized liquid introduced equals the volume of metered liquid dispensed. This relationship is maintained in this embodiment because all of the liquid displaced from the left of the piston in the FIG. 6 position of the valve necessarily exits the enclosed cylinder 157 by way of passage 186. The interconnected flush passages 198, 202, 203 and 206 to the left of the piston are closed by valve body 13.

When the valve body is oscillated back to the FIG. 7 position, piston 158 strokes from left to right. The liquid 85 is incrementally pumped from the reservoir 84 at higher pressures through delivery line 88 to upper block 2. The pressure and temperature of the pressurized liquid are continuously respectively monitored by pressure sensor 93 and temperature sensor 94. The pressurized liquid passing through the delivery line 88 enters the upper block and passes in incremental movements through the vertically extending liquid inlet passage 165 in the top modular block 2. Then the pressurized liquid sequentially and incrementally passes through top port 166 in valve sleeve 12, angular valve body passage 179, bottom port 184 in valve sleeve 12 and vertically extending passage 186 to enter the top left side of the enclosed cylinder 157 to drive piston 158 to the right as viewed in FIG. 7. A small amount of the entering pressurized liquid passes from the enclosed cylinder through the flush line system to provide some pressurized liquid turbulence in the cylinder and liquid withdrawal from the cylinder in order to avoid any liquid coagulation in the enclosed cylinder, while keeping the liquid in solution. The pressurized liquid being removed from the cylinder by the flush line system passes sequentially and incrementally through flush passages 198, 202, 203, and 206, bottom sleeve port 208, passage 181 in the valve body, top sleeve port 172, and flush passage 177A in the top body. The flushed liquid exiting the upper housing passes through the return line 110 to the liquid reservoir 84.

As the piston strokes to the right as viewed in FIG. 7, the liquid to the right of the piston gets forced from the enclosed cylinder and sequentially passes in incremental movements through passage 188, bottom sleeve port 185, valve body passage 180, top sleeve port 168, and vertical passage 170C. Liquid leaving upper block 2 then incrementally passes through metering delivery line 98 to a metered liquid mixing and dispensing station. In a hydraulic system with all passages continually filled, the amount of liquid dispensed as a shot to the station equals the amount of liquid introduced to the device during the piston displacement from left to right. The pressure of the metered liquid leaving the upper block is continuously monitored by pressure sensor 100.

Again, the continuously monitored parameters are continuously transmitted as signals to the closed loop processing system including a central processor. The central processor compares the monitored parameters to their respective specification tolerances. This permits the central processor automatically to make software adjustments during operation to keep the monitored parameters within specification tolerances resulting in the metered liquid being within specification tolerances to obtain the highest yield possible of quality product. The pressurized liquid driving the piston in one stroke becomes the liquid being incrementally displaced in the next stroke when the pressurized liquid is on the other side of the piston.

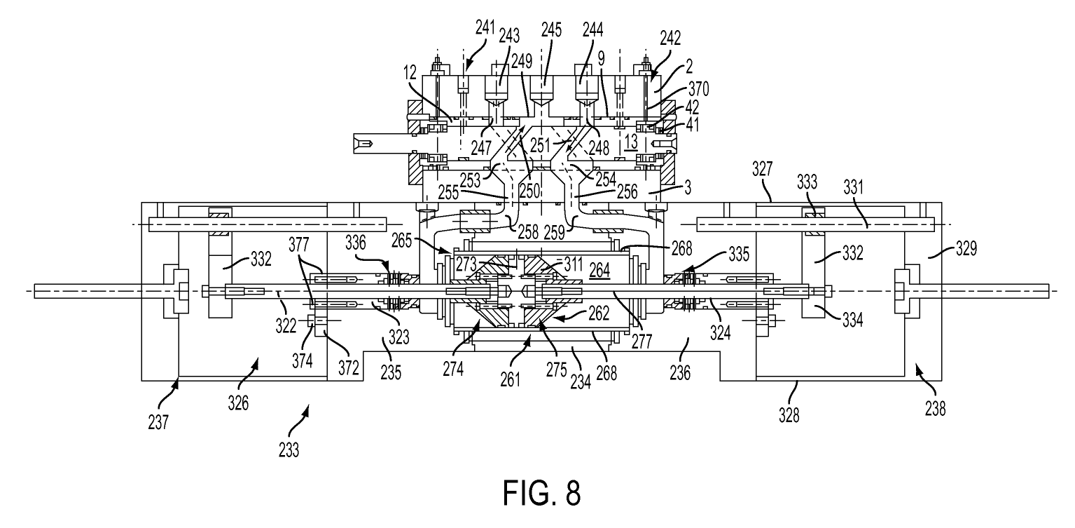

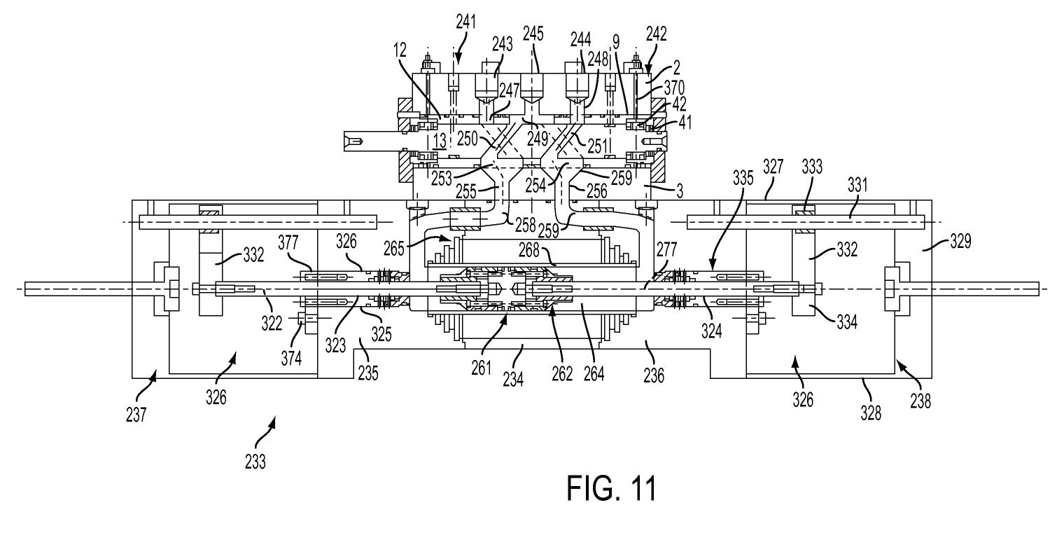

Turning now to the third embodiment shown in FIG. 8, the metering device is arranged for easy conversion of the hard tooling from a cylinder and piston of one diameter to a cylinder and piston of a different diameter. While FIG. 8 and FIG. 11 are cross sectional elevations taken generally longitudinally through the middle of the metering device, most cross sectional hatching has been omitted from these figures for clarity of illustration.

The metering device of the third embodiment includes a top block 2 and a middle block 3. The top and middle blocks are connected together by elongated bolts passing downwardly through these blocks into the modular base block assembly, indicated generally at 233. The base block assembly includes a center block 234, a left end block 235, a right end block 236, a left end cap 237 and a right end cap 238. At least one elongated horizontally extending bolt passes through left end block into the center block to removably secure the two together. At least one elongated horizontally extending bolt passes through the right end block into the center block to removably secure the two together. The left and right end caps 237 and 238 are respectively bolted to the left and right end blocks 235 and 236.

The top and middle blocks cooperatively define a longitudinal bore 9. The longitudinal bore 9 receives a fixed valve sleeve insert 12. A valve body 13 is rotatably mounted in the valve sleeve by thrust bearing assemblies 41 at each end thereof. The valve body 12 is also sealed to valve sleeve insert 12 by seal assembly cartridges 42 at each end thereof. The seal assemblies have two axially spaced seals and an intermediate inert cavity as shown and described in the context of FIG. 4. The metering device of FIG. 8 also has a flush system, indicated generally at 241, and a weep witness monitoring system, indicated generally at 242, as described in more detail in conjunction with FIGS. 4 and 5.

The top block 2 of FIGS. 8 and 11 includes left and right vertically extending pressurized liquid inlet passages 243 and 244, respectively. A vertical outlet passage 245 is positioned between them. The left vertical inlet passage 243 communicates with left inlet port 247 in the top of valve sleeve 12. The right vertical inlet passage 244 communicates with a right longitudinally spaced inlet port 248 in the top of valve sleeve 12. An elongated outlet port 249 in the top of valve sleeve 12 is positioned between longitudinally spaced inlet ports 247 and 248. The rotatable valve body 13 has left and right parallel angled passages 250 and 251 passing therethrough The bottom of sleeve 12 is provided with left and right elongated spaced ports 253 and 254. Elongated left bottom port 253 communicates with vertical passage 255 in middle block 3, which in turn communicates with a left curved passage 258 extending through the center block and the left end block into the left end of the piston cylinder assembly, indicated generally at 261. Elongated right bottom port 254 communicates with right vertical passage 256 in middle body 3. The bottom of passage 256 communicates with right curved passage 259 extending through the center block and right end block into the right end of the piston cylinder assembly 261.

As is apparent from FIG. 8, rotation of valve body 13 through 180° will reorient the inclination of the two parallel valve body passages 250 and 251 between the positions represented by the solid and dotted lines in FIG. 8. When in the solid line position of the valve passages, pressurized liquid sequentially and incrementally passes through inlet passage 244, top sleeve port 248, valve passage 251, bottom sleeve port 254, vertical passage 256 and right curved passage 259 to enter the right end of piston cylinder assembly 261. Pressurized liquid entering the right end of enclosed cylinder 264 forces the piston, indicated generally at 262, to the left as viewed in FIG. 8. This piston stroke incrementally forces liquid to the left of the piston based on its displacement through left curved passage 258, passage 255, elongated bottom sleeve port 253, left angled valve passage 250, elongated outlet sleeve port 249 and outlet passage 245. Rotation of the valve body to the dotted line position in FIG. 8, will reverse the liquid flow so that pressurized liquid enters the left end of the piston cylinder assembly 261, incrementally forces the piston 262 to the right and dispenses the liquid from the right end of the piston cylinder assembly 261. Oscillating rotary motion of the valve body results in piston reciprocation and having the pressurized liquid during one stroke become the incrementally dispensed liquid during the next stroke. With the passages in the metering device filled with liquid, the volume of liquid dispensed as a shot to the mixing and dispensing station equals the volume of liquid inserted into the metering device by the piston displacement.

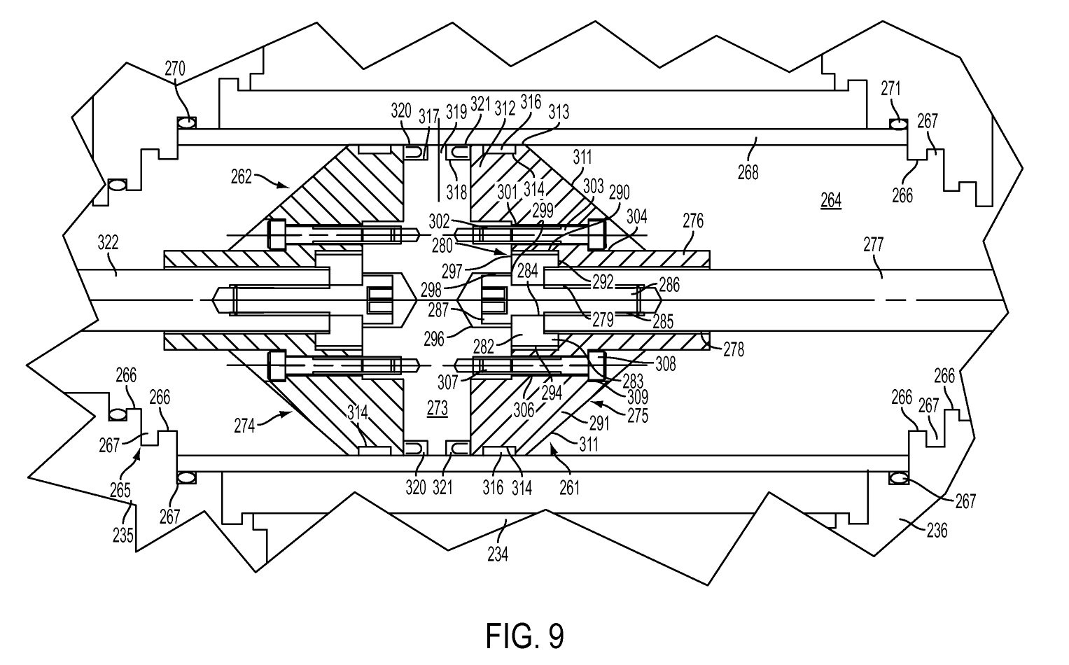

The piston and cylinder assembly 261 can readily have its diameters changed as needed for a specific application, without changing the hard tooling and without requiring special tools. Each of the end blocks cooperatively forming the enclosed cylinder 264 are provided with radially ascending annular steps, indicated generally at 265. The ascending annular steps 265 formed on the inner facing ends of the left and right end blocks have a general square wave pattern. As best illustrated in FIG. 9, this pattern forms annular horizontal steps 266 and adjacent annular seal pockets 267. As shown by way of example only, there are four annular steps 266 and seal pockets 267 having different diameters at each end of the enclosed cylinder 264. The opposing annular steps are longitudinally aligned to receive different diameter cylindrical tubes or sleeves 268. The cylindrical sleeve 268 cooperates with the radially ascending annular steps on the inner ends of the left and right end blocks to define the enclosed cylinder 264. Left and right annular O-ring seals 270 and 271 are positioned and compressed in the seal pockets 267 at each end of the cylinder to seal the selected diameter sleeve 268 to the left and right modular end blocks. Similarly, the piston 262 can be assembled from standardized part sets to have an outer diameter corresponding to the inner diameter of the sleeve 268.

Further with respect to FIG. 9, the component details of the piston cylinder assembly 261, the piston assembly 262 and the interconnection between the piston and piston rods are shown in larger scale. The piston, indicated generally at 262, consists of three main parts. The piston center 273 is flanked by left and right mirror image piston halves 274 and 275, respectively. The piston center is shown without cross section lines for clarity of illustration. Since the piston halves are mirror images of one another, only right piston half 275 will be described in detail.

Right piston half 275 includes a tubular extension 276 which receives right piston rod 277. A small gap 278 exists between the outer diameter of piston rod 277 and the inner diameter of tubular extension 276. Piston rod 277 is provided with an axially extending threaded bore 279 in its left end. The left or inner end of piston rod 277 has a connected piston collar or head, indicated generally at 280. The piston collar 280 includes an end wall 282 and a peripheral skirt 283 that surround the left end of piston rod 277. The piston collar end wall 282 has a hole 284 therein that receives the threaded shank 285 of bolt 286. The head 287 of the threaded bolt 286 is threaded tight against the end wall 282 of piston collar 280 to force the collar against the end of the piston rod. In this position, the piston collar 280 is received in an axially centered counterbore 290 in the right half piston body 291. The end of the skirt 283 on the piston collar is positioned against the blind end face 292 of counterbore 290. The counterbore 290 has a diameter slightly larger than the diameter of the skirt 283 on the piston collar 280 to faun a gap 294 therebetween. The head 287 of the bolt 286 is received in an oversized recess 296 in vertical right wall 297 of piston center 273 to provide an annular gap 298 between the bolt head and the wall of recess 296. When the bolt 286 is threaded tight, a small gap 299 exists between the end wall 282 of the piston collar 280 and the adjacent vertical wall 297 of the piston center 273. These gaps allow the piston and piston rod and collar to have some relative dimensional freedom therebetween in order to “float” or self center. This minimizes the chances of binding and allows the piston to travel a straighter path to enhance the life of the seals and wear plates.

The right piston half 275 has an upper horizontally extending bore 301 therethrough positioned above piston rod 277 and piston collar 280. Bore 301 is in alignment with a tapped hole 302 in vertical wall 297 on the piston center. A bolt 303 is threaded through upper bore 301 into tapped hole 302 to removably secure the piston half to piston center 273. The upper bore 301 has an end counterbore 304 so that the head of bolt 303 is received in the counterbore. A similar removable connection is made below the piston and piston rod. A second lower horizontal bore 306 in the body 291 of right piston half 275 is provided. Lower tapped hole 307 in vertical wall 297 of piston center 273 is aligned with the lower connection bore 306 in the right half piston body 291. A second lower bolt 308 is threaded into the second lower bore 306 and tapped hole 307 to removably connect the piston half to the piston center. The head of lower bolt 308 is received in counterbore 309 in the piston half. While two removable connection bolts are shown, it will be appreciated that additional bolts may be used as required by the size of the piston or alternate fastening means may also be used. To assemble a piston of selected diameter, the piston collar is first connected to the piston rod. The piston collar and rod are then assembled in piston half 275. The assembled piston half carrying the piston and piston collar is then connected to the piston center 273 by upper and lower bolts 303 and 308. To disassemble the piston once it is exposed, the reverse steps are followed.

The piston half 275 preferably has an outwardly facing end wall 311 that is generally conical in shape, although other shapes operative to efficiently displace the liquid may also be used. End wall 311 extends from a cylindrical piston base 312 adjacent the inner diameter of cylinder sleeve 268 to tubular extension 276. This generally conical shape for end wall 311 at each end of piston 262 reduces the piston weight and has an angle generally corresponding to the angle defined by the annular steps 266 at each end of the enclosed cylinder to efficiently push the liquid out of piston cylinder assembly 261. The cylindrical base 312 of the right piston half 275 has an annular peripheral wall 313 that abuts the piston center at its inner end and intersects with the periphery of the conical surface 311 at its outer end. The annular wall 313 of the cylindrical base 312 of the piston half has an outer diameter that is slightly less than the inner diameter of the cylinder sleeve 268. The annular wall 313 has an annular longitudinal groove 314 therein that receives an, annular wear plate 316. The wear plate extends radially outwardly slightly beyond the outer wall 313 to be in reciprocal sliding contact with the inner diameter of cylinder 268. The wear plate over many cycles incurs the wear leaving the piston half unworn along that outer base wall 313 allowing the annular wear plate to be replaced in annular groove 314 without having to replace the piston half.

The piston center 273 has left and right longitudinally spaced annular seal cutouts 317 and 318 in its peripheral outer wall. The seal cutouts are separated by a radially extending annular partition 319 in the outer wall of the piston center. The outer end of annular partition 319 is slightly smaller in diameter than the inner diameter of cylinder 268 in order to avoid wear. The left and right seal cutouts separated by the partition respectively receive radially outwardly biased left and right annular lip seals 320 and 321. These lip seals extend slightly radially beyond the partition 319 and cylinder base 312. The lip seals are in sliding and sealing contact with the inner diameter of cylinder 268. As the seals become worn after many repeated cycles, they can be replaced while repeatedly reusing the same piston center that is not subject to wear.

As described above, the right and left piston rods 277 and 322 are connected to and extend axially from opposite sides of the composite piston 262. As best shown in FIGS. 8, 10 and 11, the piston rods 277 and 322 are respectively received in oppositely axially extending left and right bores 323 and 324 in seal assembly cartridges 336 and 335 in left and right modular end blocks 235 and 236. The left and right end caps 237 and 238 are respectively connected to left and right bottom end blocks 235 and 236. The end caps are covered with a housing having a configuration exposing the elongated bolts connecting the end blocks to the center block. The left and right end caps 237 and 238 are hollow and include a piston rod guidance and reinforcement framework cage, indicated generally at 326. The framework cages are mirror images of one another so only one framework end cage will be described. Right end cap 238 includes horizontal parallel top and bottom, frame members 327 and 328, respectively, and vertical end frame 329. A horizontal guide rod 331 extends between and is connected to the right end block 236 and vertical end frame 329. A vertical reinforcement member 332 has an upper hole 333 that receives horizontal guide rod 331 to permit reciprocal movement of the vertical reinforcement member relative to the guide rod. The bottom end 334 of the vertical reinforcement member 332 is releasably connected to the right end of piston rod 277. As the piston rod reciprocates, its end is reinforced and held against rotation by the vertical reinforcement member 332 sliding along guide rod 331. While not shown in FIG. 8 or 11, it will be appreciated that the vertical reinforcement member 332 could extend near the bottom horizontal frame with a magnet thereon cooperating with an encoder to monitor the position, direction and speed of piston 262.

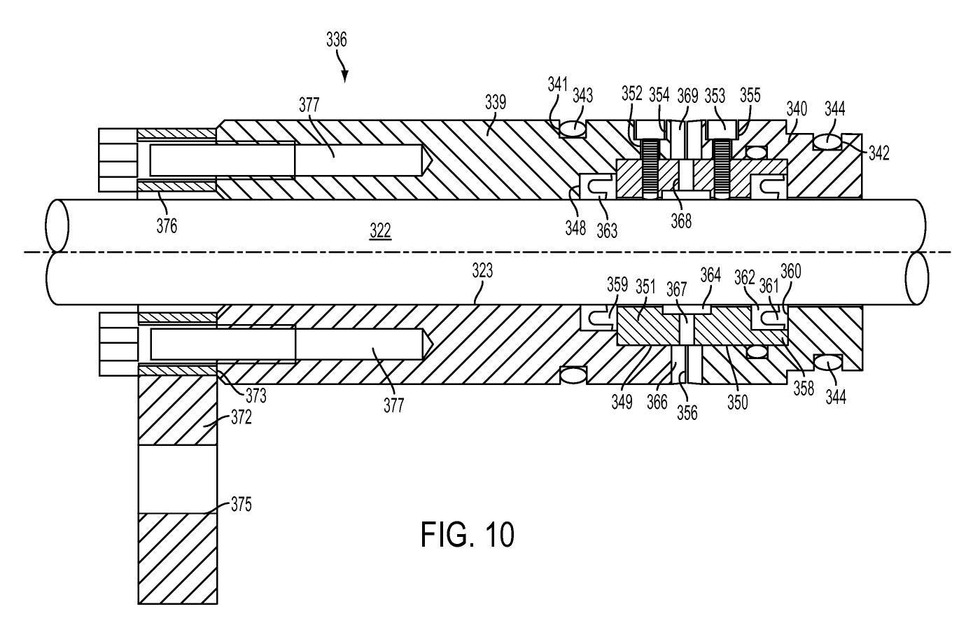

The right and left piston rods 277 and 322, respectively, are each sealed to their respective bores 324 and 323 in right and left seal assembly cartridges 335 and 336, respectively. The seal assembly cartridges are mirror images of one another so only left seal assembly cartridge 336 will be described in detail. Referring to FIG. 10, the seal assembly cartridge, indicated generally at 336, includes a first generally cylindrical left body 339 selectively interconnected with a second generally cylindrical right body 340. The first seal body 339 has an annular peripheral groove 341 therein and second seal body 340 has an annular peripheral groove 342 therein. As best shown in FIGS. 8 and 11, annular O-rings 343 and 344 are respectively received in annular grooves 341 and 342 and are compressed to form a tight seal at their respective interfaces with bore wall 325 in the left end block 235. The left seal assembly module 336 has an axial bore 323 extending therethrough, which receives left piston rod 322 for axial reciprocation.

The left cylindrical seal body 339 has left and right annular grooves 348 and 349 extending radially outwardly from bore 323. The right generally cylindrical seal body 340 has an annular groove 350 extending radially outwardly from the bore 323. The right groove 349 in the left seal body has the same diameter as groove 350 in the right seal body and together they cooperatively form an annular cavity. The annular cavity receives a bridging annular sealing insert 351, which is removably secured in place within the cooperatively formed cavity by two longitudinally spaced bolts 352 and 353. The heads of bolts 352 and 353 are received in left and right counterbores 354 and 355 in the left and right seal bodies, respectively to provide a flush continuous outer surface on the first and second seal bodies. The sealing insert when secured in place by bolts 352 and 353 holds the first and second seal bodies together in axial alignment and with their ends in flush abutment as shown at 356.

The sealing insert 351 has an outer longitudinal annular flange 358 extending from its right end as viewed in FIG. 10. The left annular groove 348 in left seal body 339 and the left end of the seal insert 351 cooperatively define a first annular seal pocket 359. The right end of seal insert 351, longitudinally extending annular flange 358 and the right radially extending annular wall 360 of groove 350 in the second cylindrical seal body 340 cooperatively define a second seal pocket 361. The second seal pocket receives the primary annular lip seal 362, which is radially biased inwardly into a compression interface seal with the axially reciprocating piston rod 322. The first or left seal pocket 359 receives the secondary annular lip seal 363, which is radially biased inwardly into a compression interface seal with the axially reciprocating piston rod 322.

An annular inert liquid cavity 364 is provided in seal insert 351 and is positioned between the primary and secondary lip seals 362 and 363, respectively. The annular inert liquid cavity 364 includes inlet and outlet inert liquid passages. The inert liquid inlet passage is cooperatively defined by a passage 366 formed by mating cutouts in the abutting left and right seal bodies communicating with the lower end of a vertical bottom passage in the 367 in the seal insert 351. The top end of seal insert passage 367 communicates with the annular inert liquid cavity 364. The inert liquid outlet passage includes a vertically upwardly extending passage 368 in the bridging seal insert 351. The upper end of passage 368 communicates with a passage 369 cooperatively formed by cutouts in the mating abutting ends of the left and right seal bodies 339 and 340. The inert liquid inlet passage is positioned at the bottom of the seal assembly cartridge and the inert liquid outlet passage is positioned at the top of the seal assembly cartridge diametrically opposed from one another. By having the flow of inert liquid be generally upwardly through the seal assembly, any air entrained in the inert liquid will rise to the top of the weep witness system into the air column above the level of the inert liquid in the weep witness gauges.

The inert liquid passes upwardly through the cooperating inlet passages 366 and 367 and then around piston rod 322 in either circumferential direction in annular cavity 364. The inert liquid reunites at the top of the annular inert liquid cavity and passes upwardly through the inert cavity outlet passage formed by outlet passages 368 and 369. The annular inert liquid cavity 364 and the bottom inlet passage to and the top outlet passage from that annular cavity are part of a weep witness system 242. As best shown in FIGS. 8, 10 and 11, the weep witness system further includes a fill conduit in the bottom portion of the left end base block 235 leading to the bottom inlet passage 366 and an inert delivery passage leading from the top outlet passage 369 upwardly through the top portion of the left end base block. A delivery line communicates with and leads from the outlet passage from the left end block to the weep witness monitoring gauge, as described above in the context of FIGS. 4 and 5. The entire weep witness system is filled with inert liquid up to its predetermined beginning reference level in the weep witness gauges.

Any pressurized liquid ultimately seeping through the primary seal 362 will bear against the inert liquid in the filled annular inert liquid cavity 364. This will force the inert liquid in the weep witness system to rise in the monitored weep witness gauge as described above. The monitored amount and incremental frequency of rise in the weep witness gauges are used to predict the life of the primary seal and to allow routine maintenance to be performed to replace the main seal or seal assembly cartridge 336 with a new seal or cartridge prior to any failure. It is preferred that both the valve seal assembly cartridge and the piston rod seal assembly have weep witness monitoring capabilities in all metering devices of this invention using piston rods. In those embodiments in which piston rods may not be used to save space, for example as shown in FIG. 2, the valve seal cartridges are provided with a weep witness gauge system.

A retention plate 372 is removably secured to the left end block 235 by an elongated threaded bolt 374 (FIG. 8) passing through hole 375 in the retention plate into the left end block. The retention plate 372 has a bore 376 passing therethrough which is in axial alignment with bore 323 in seal assembly cartridge 336. The bore 376 is of slightly larger diameter than the bore 323 to allow the retention plate 372 to be easily removed and to eliminate any interference with the piston rod during operation. The retention plate 372 is further secured to the left cylindrical seal body 339 by elongated longitudinal bolts 377 passing through the retention plate into the cylindrical seal body 339. Bolt 374 securing the retention plate to the left end block 235 and bolts 377 securing the retention plate to the cylindrical seal body eliminate any possible rotation of the seal assembly cartridge during operation. The entire seal assembly cartridge 336 can be removed and replaced with a new seal assembly cartridge during normal maintenance. For this purpose, end cap 237 is unbolted and removed, piston rod 322 is disconnected from vertical reinforcement member 332, retention plate 372 is removed, and seal assembly cartridge 336 is removed from the piston rod and replaced with a new seal assembly cartridge. The maintenance process is then reversed to reinstall the retention plate 372 reconnect the piston rod 322 to the vertical reinforcement member and reconnect end cap 237 to left end block 235.

The same maintenance procedures, could also be performed to replace the right seal assembly cartridge 335. Alternatively, if only the primary seal 362 is in need of replacement, the seal assembly cartridge can be disassembled by removing bolts 352 and 353 to separate the left seal body 339 from the right seal body 340 and withdraw the bridging seal insert 351. The worn primary seal 362 can then be replaced and the seal assembly cartridge reassembled. The replacement of only the primary seal is performed without any special hand tools being used.

As is apparent from the above description, the diameter of the piston and cylinder can be chosen for a desired metering application without changing hard tooling and without requiring special tools. Turning now to FIG. 11, a smaller diameter piston has been chosen with a smaller diameter cylinder than that shown in FIG. 8. To implement this change, the vertical bolts connecting the top and middle blocks 2 and 3 to the left base block 235 are removed. The elongated longitudinal bolts connecting left end block 235 to center block 234 are removed and the right end piston rod connection to the vertical retention member 332 is disconnected after removing right end cap 238. The left end cap, left end block 235, the piston rods and piston and the cylinder sleeve 268 can then be withdrawn to the left as viewed in FIG. 11, thereby opening the central block 234 to maintenance access. The cylinder sleeve 268 is then slid off the piston, and the piston 262 is disassembled and removed from the piston rods. A new piston 262 having the same construction components of the piston shown in FIG. 9 but with a smaller outside diameter is then assembled with the piston rods 277 and 322. Annular 0 ring seals are then positioned in and protrude slightly from the seal pockets 267 adjacent the steps 266 corresponding to the outer diameter of the new sleeve. A new smaller diameter cylinder sleeve 268 as shown in FIG. 11 is then slid over the new smaller diameter piston 262. The left end cap and left end bottom block 235 with the new diameter piston and sleeve mounted thereon are then slid to the right as viewed in FIG. 11. The piston rod 277 is received in bore 324 in right end seal cartridge 335 to help guide sliding movement of left end block toward the center block and right end block. When the left end block is fully mated with the center block, the smaller diameter sleeve has radially compressed the O-ring seals 271 and is seated on the steps 266 at each end of the newly reformed piston cylinder assembly. The right end of piston rod 277 is then reconnected to vertical reinforcement member 332 and right end cap 238 reinstalled. Finally, elongated horizontal bolts are then reinstalled to reconnect left end bottom block 235 to central block 234, and vertical elongated bolts are reinstalled to reconnect top and middle blocks 2 and 3 to left end block 235. The entire changeover from the larger piston and cylinder sleeve diameter of FIG. 8 to the smaller piston and cylinder sleeve diameter of FIG. 11 is accomplished with the same hard tooling and readily available conventional hand tools, such as wrenches. While this piston cylinder conversion has been described by removing the left end cap and left end block, it will be readily appreciated that the conversion can be made in the same manner by removing the right end cap and right end block.

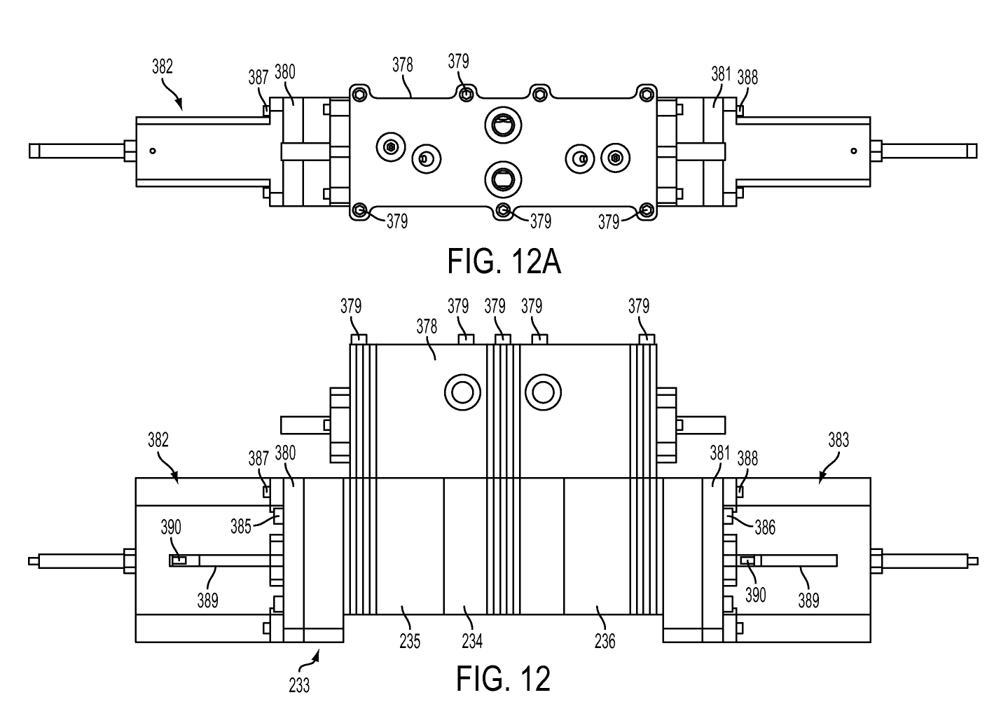

Turning now to the fourth embodiment shown in FIGS. 12 through 16, the hard tooling of the metering device may be changed to a micro metering device without changing the hard tooling and without requiring any special tools. The term micro metering as used herein means that the amount of metered liquid dispensed is less than would be provided if the full surface area of the piston was used as the pressure plate against the metered liquid. In the present embodiment, the amount of micro metered liquid can readily be changed to fit any metering liquid and/or application.

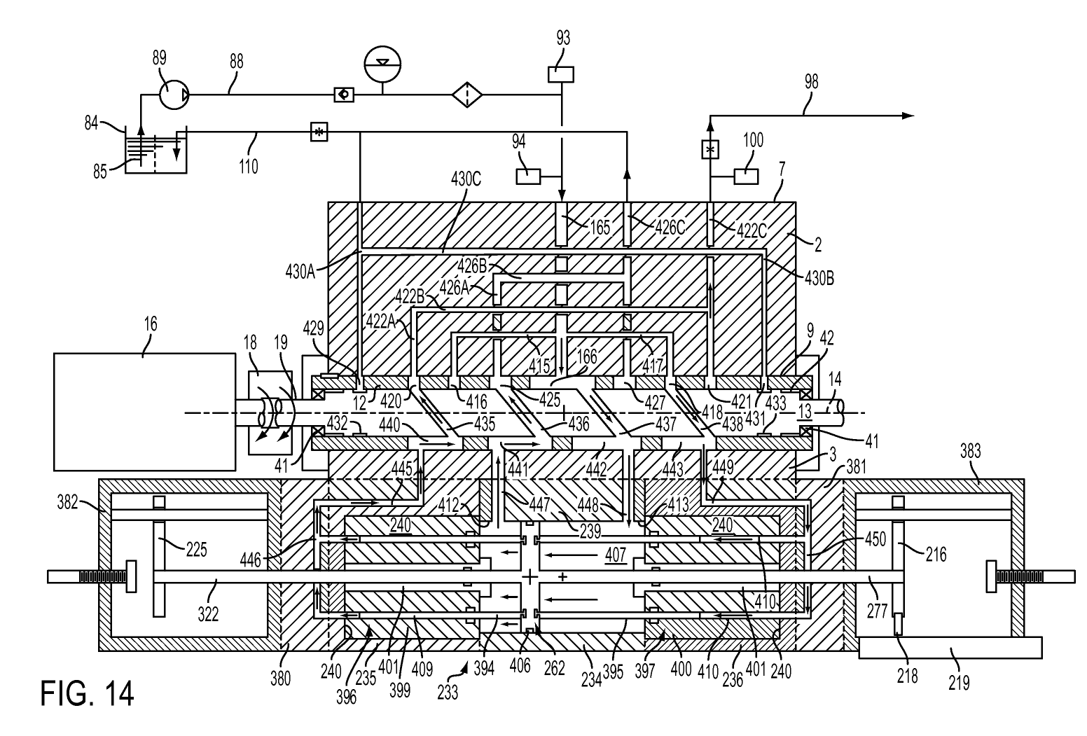

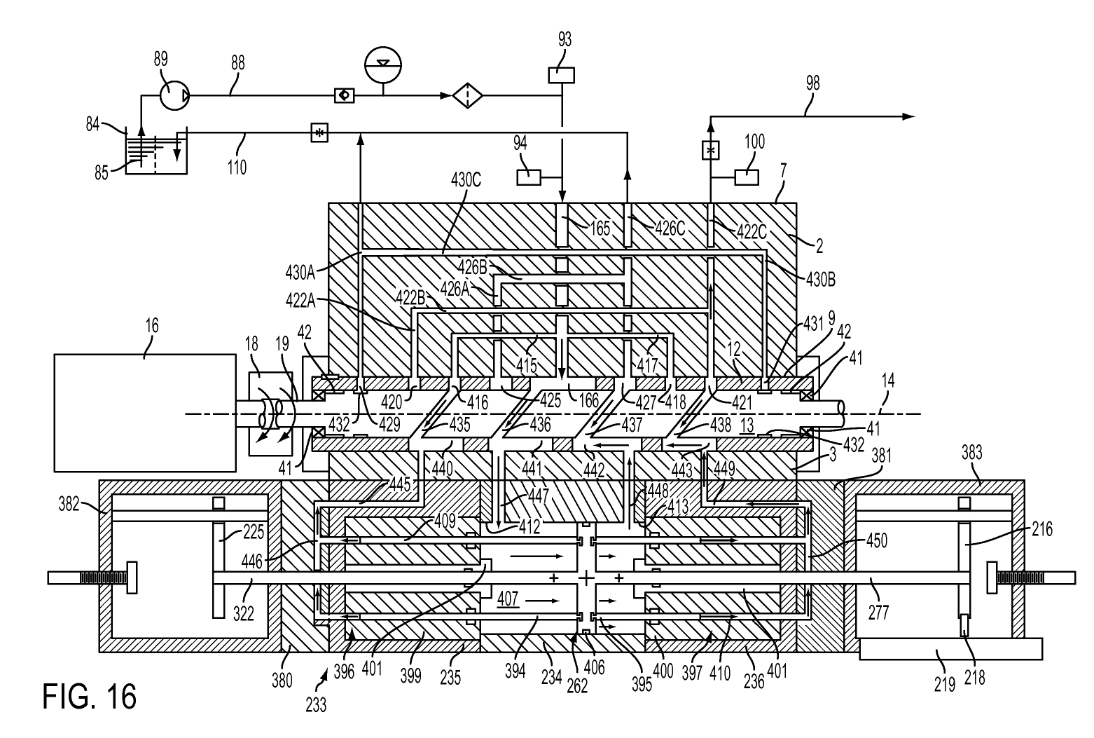

In FIGS. 12 and 12 A, the micro metering device includes a valve housing 378 enclosing upper and middle blocks 2 and 3. These blocks are mounted on top of the base block assembly 233 by elongated bolts 379. This base assembly includes center block 234, left and right end blocks 235 and 236, left and right sleeve insert retaining manifolds 380 and 381 and left and right caps 382 and 383. The left end block 235 and left sleeve insert retaining manifold 380 are connected to the center block by removable elongated bolts 385. The right end base block 236 and right end sleeve insert retaining manifold 381 are connected to the center block by removable elongated bolts 386. As best shown in FIGS. 14 and 16, the center block has a bore 239 therethrough and the left base block and right base block have blind end bores 240 therein. Left end cap 382 is connected to the left end manifold and left end block by removable bolts 387, and right end cap 383 is connected to the right end manifold and right end block by removable bolts 388. The numerous removable bolts described allow for easy disassembly of some or all of the components as needed for maintenance purposes as described above. When so assembled, the bore 239 in the center block and the blind end bores 240 in the left and right base end blocks cooperatively define enclosed cylinder 407. As shown in FIG. 12, the end cap housings each have an elongated rectangular window 389 in vertical alignment with the piston rod end reciprocating therein. The end of the reciprocating piston rod has a flat surface or other marking or indicia 390 thereon which is visible through window 389. The operator can thus look through the window to make sure the piston rod indicia is axially reciprocating as a visual check for proper operation.

As best shown in FIGS. 14 and 16, top block 2 and middle block 3 cooperatively define horizontal bore 9. The bore receives a valve sleeve 12 fixed thereto. A valve body 13 is rotatably mounted in the valve sleeve by thrust bearings 41 for selective rotation about longitudinal axis 14. The valve body is sealed to the sleeve 12 by seal assembly cartridges 42. The integral valve body drive shaft 19 is coupled at 18 to a servo motor 16. The reversible, variable speed servo motor rotates the valve body, preferably in 180° continuous oscillations, to meter precise amounts of liquid shots from the micro metering device.

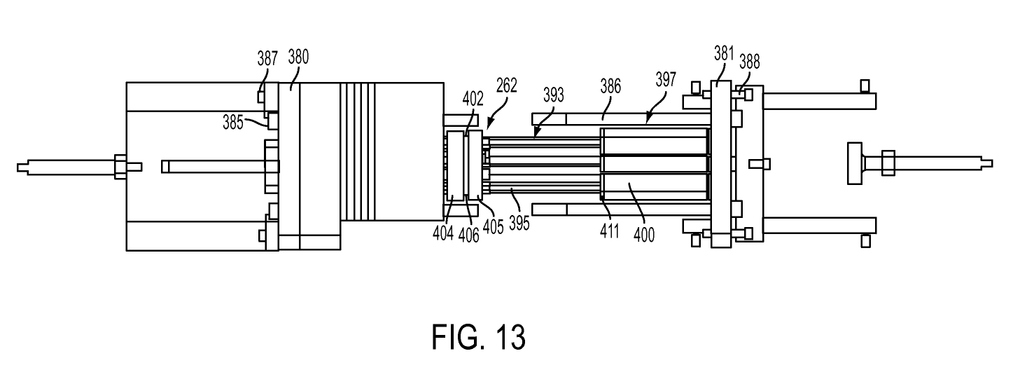

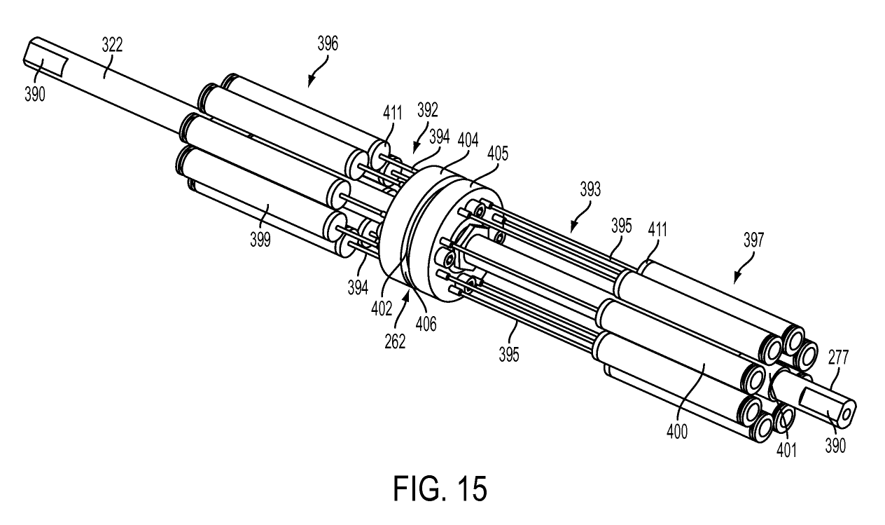

In FIG. 13, the center block 234, right end block 236, piston cylinder sleeve and the housing for right end cap 383 have been removed to expose the piston, needle piston rods and piston sleeve inserts. FIG. 15 discloses a perspective view of the piston, indicated generally at 262, left and right main piston rods 322 and 277 axially extending from both sides of the piston, circumferentially spaced left and right arrays 392 and 393 of left and right needle piston rods 394 and 395 axially extending from both sides of the piston and left and right circumferential arrays 396 and 397 of left and right piston sleeve inserts 399 and 400 positioned at each end of the enclosed cylinder 407. The left and right main piston rods 322 and 277 are positioned in and sealed to wear sleeves 401. The outer ends of the left and right piston rods extend into the left and right end caps 382 and 383 and are guided and reinforced as described above. The position, speed and direction of the piston 262 are continuously monitored by magnet 218 and elongated encoder 219. The circumferential arrays of piston sleeve inserts surround the main piston rods and protective wear sleeves 401 as best shown in FIG. 15.

As best shown in FIGS. 13 and 15, the piston 262 has three component parts. The center body 402, acts as a mount for the piston rods and micro piston rods. Left and right piston rod retaining halves 404 and 405 respectively secure the heads of the main piston rods 322 and 277 and the heads of the micro piston rods 394 and 395 to the center body. Preferably, the heads of the piston rods and micro piston rods are secured in the piston retaining halves 404 and 405 and piston center 402 with small gaps therebetween to allow slight freedom of relative movement therebetween to provide self centering and to avoid binding during operation. The end halves 404 and 405 are then bolted to the piston center body 402 to complete the piston rod and micro piston rod assembly. Piston center body 402 is slightly smaller in diameter than the end halves 404 and 405 cooperatively to form a seal groove 406. This seal groove contains an annular seal that is in sliding compressed contact with the inner diameter of the enclosed cylinder 407.

As best shown in FIGS. 13-15, the left needle piston rods 394 are respectively partially received in and sealed to axially aligned bores 409 in the left piston sleeve inserts 399. The right needle piston rods 395 are respectively partially received in and sealed to axially aligned bores 410 in the right piston sleeve inserts 400. The seals are carried by micro piston rod seal retainers 411 mounted on the inner ends of the left and right piston sleeve inserts as clearly shown in FIGS. 13 and 15.

The inside diameter of the bore 239 in center block 234 is slightly less than the inside diameters of the bores 240 in left and right end blocks 235 and 236 cooperatively to define left and right radially extending annular shoulders 412 and 413. These shoulders in conjunction with the heads on the protective wear sleeves 401 for the main piston rods act to hold the inner surfaces of the piston sleeve inserts in the left and right arrays in position. The other or outer ends of the piston sleeve inserts in the left and right arrays 396 and 397 are held in position by the ends of the blind end bores 240 in the left and right end blocks 235 and 236. The annular shoulder and protective piston sleeve head at the inner end and the blind end bore at the other outer end removably confine the circumferential arrays of piston sleeve inserts in their respective positions at each end of the enclosed cylinder. The amount of liquid micro metered from the piston sleeve inserts can be changed in several ways. For example, the number of piston sleeve inserts in the array can be varied, the diameter of the bores through the piston sleeve inserts in the array can be varied from one piston sleeve insert to the next, and/or different diameter bores in the piston sleeve inserts can be used.

The micro metering of liquid using needle piston rods and piston sleeve inserts is best understood in the context of FIGS. 14 and 16. The cross sectional hatching has been omitted from the valve body, piston and piston rods for clarity of illustration. A top block 2 and a middle block 3 cooperatively define a horizontal bore 9 receiving a fixed sleeve 12 and rotating valve body 13. The top block 2 in the micro metering device includes a vertical pressurized liquid inlet passage 165 extending from the top of top block 2 to an elongated inlet port 166 in sleeve 12. The pressurized liquid inlet system further includes a first L shape inlet passage 415 extending to the left from the inlet passage 165 to a port 416 in sleeve 12. The pressurized liquid inlet system also includes a second L shape inlet passage 417 extending to the right from inlet passage 165 to an inlet port 418 in sleeve 12.

The top block and sleeve also include a liquid dispensing port and passage system. Valve sleeve 12 is provided with a first left dispensing port 420 and a second horizontally spaced right dispensing port 421. The left dispensing port 420 communicates with vertical dispensing passage 422A, which in turn communicates with horizontal header dispensing passage 422B. Header passage 422B intersects and communicates with vertical dispensing passage 422C that extends from the right dispensing port 421 in the sleeve to the top surface 7 of the top block 2.

The top block and sleeve also include a liquid return port and passage system. Sleeve 12 has a left liquid return port 425 communicating with first vertical liquid return passage 426A. Return passage 426A communicates with horizontal header return passage 426B. Return passage 426B communicates with second vertical liquid return passage 426C, which extends from right liquid return port 427 in the sleeve to the top wall 7 of top block 2.

The top block and sleeve also include a liquid flush port and passage system. Sleeve 12 has a left flush port 429 communicating with a left vertical flush passage 430A extending from the sleeve to the top wall of the top block. A right horizontally spaced flush port 431 communicates with second vertical flush passage 430B and horizontal header flush passage 430C. Horizontal passage 430C delivers flush liquid from right vertical flush passage 430B to left vertical flush passage 430A for upward removal from top block 2. The left and right horizontally spaced flush ports 429 and 431, respectively communicate with horizontally spaced left and right annular grooves 432 and 433 in the outer circumferential surface of valve body 12. These annular grooves and ports collect any pressurized liquid migrating along the interface between the valve body and sleeve for removal through flush lines 430A, 430B and 430C. Removal of this pressurized liquid through the flush port and passage system protects the seal assembly cartridges 42 at each end of the valve body as described in more detail above.

The valve body 12 has four spaced and parallel angularly oriented passages 435, 436, 437 and 438 therein. These four angular passages communicate with different ports depending on the position of the valve body as will be described in more detail below. FIG. 14 represents one position of the valve body and FIG. 16 represents a second position of the valve body rotated approximately 180° from the first position.

The sleeve 12 also has four bottom horizontally spaced elongated ports 440, 441, 442 and 443. These bottom ports in the sleeve are positioned 180° from the ports 420, 416, 425, 166, 427, 418 and 421. Port 440 communicates with a left L shape passage 445 passing through the middle block 3 and left end block 235. The left L shape passage 445 communicates with left manifold passage 446 which in turn communicates with the left end of each of the bores 409 in piston sleeve inserts 399 positioned in the array 396 at the left end of enclosed cylinder 407. Port 441 communicates with a vertical passage 447 extending through the middle block 3 and the central base block 234 to an opening in enclosed cylinder 407 between the piston 262 and the left array 396 of piston sleeve inserts 399. Port 442 communicates with a vertical passage 448 extending through middle block 3 and central base block 234 to an opening in enclosed cylinder 407 between piston 262 and the right array 397 of piston sleeve inserts 400. The port 443 communicates with a right L shape passage 449 extending through middle block 3 and right base block 236. The right L shape passage 449 communicates with right manifold passage 450, which in turn communicates with the right end of each of the bores 410 in piston sleeve inserts 400 positioned in the array 397 at the right end of enclosed cylinder 407.

Turning now to the operation of the micro metering device and initially to FIG. 14, liquid 85 is incrementally drawn from reservoir 84 by pump 89. The pressurized liquid leaving the pump passes in incremental movements through delivery line 88 in which its pressure is monitored by pressure sensor 93 and its temperature is monitored by temperature sensor 94. The pressurized liquid incrementally passes from delivery line 88 into vertical passage 165 in top block 2. In the valve position shown in FIG. 14, the pressurized inlet liquid sequentially and incrementally passes through vertical passage 165, port 166 in the upper portion of valve sleeve 12, angled passage 437 in the valve body, elongated port 442 in the lower portion of valve sleeve 12, and vertical passage 448 into enclosed cylinder 407 to the right side of the piston 262. The pressurized liquid forces the piston to the left as viewed in FIG. 14

Pressurized fluid entering vertical passage 165 is also simultaneously passing pressurized liquid in incremental movements through right L shape inlet passage 417, port 418 in the upper portion of valve sleeve 12, angled passage 438 in the valve body, port 443 in the lower portion of valve sleeve 12, right L shape passage 449 and right manifold passage 450 into the right end of each of the bores 410 of the right piston sleeve inserts 400. The pressurized liquid forces the micro piston rods 395 to the left as viewed in FIG. 14, while maintaining the filled state of each of the bores 410 right of the ends of needle piston rods 395 with pressurized liquid.

As the piston 262 moves to the left in FIG. 14, the liquid between the piston 262 and the left array 396 of piston sleeve inserts 399 is returned in incremental movements to the reservoir while the liquid in the bores 409 to the left of the micro piston rods 394 is delivered in incremental movements to the mixing and dispensing station. With respect to the liquid to the left of piston 262, it is forced sequentially and incrementally through vertical passage 447, port 441 in the lower portion of valve sleeve 12, angled valve body passage 436, port 425 in the upper portion of the valve sleeve, and return passages 426A, 426B and 426C. Liquid leaving the top block 2 via vertical passage 426C incrementally passes through return line 110 back to reservoir 84. With respect to the liquid to the left of arrayed needle piston rods 394, it collectively passes in incremental movements corresponding to piston displacements through left manifold passage 446, left L shape passage 445, port 440 in the lower portion of valve sleeve 12, angled passage 435 in the valve body, port 420 in the upper portion of the valve sleeve, and dispensing lines 422A, 422B and 422C. Liquid incrementally dispensed from the vertical passage 422C passes through delivery line 98 to a mixing and dispensing station. The pressure of the liquid in delivery line 98 is continuously monitored by pressure sensor 100. The precise amount of the micro shot dispensed is calculated by the microprocessor from the known piston displacement and the known areas of the bores 409 in piston sleeve inserts 399.

As will be appreciated by the description of the operation of the micro metering device of FIG. 14, the collective area of the ends of the needle piston rods is considerably smaller than the area of the right side of piston 262. Accordingly, the pressure of the liquid driving the piston to the left as viewed in FIG. 14 can be considerably less than the pressure level normally used.

The valve body 13 then rotates 180° to the position shown in FIG. 16. Turning now to the operation of the micro metering device in its FIG. 16 position, liquid 85 is incrementally drawn from reservoir 84 by pump 89. The pressurized liquid leaving the pump passes in incremental movements through delivery line 88 in which its pressure is continuously monitored by pressure sensor 93 and its temperature is continuously monitored by temperature sensor 94. The pressurized liquid incrementally passes from delivery line 88 into the vertical passage 165 in top block 2. In the valve position shown in FIG. 16, the pressurized inlet liquid sequentially passes in incremental movements through vertical passage 165, port 166 in the upper portion of valve sleeve 12, angled passage 436 in the valve body, port 441 in the lower portion of the valve sleeve, and vertical passage 447 into enclosed cylinder 407 between the left side of piston 262 and the left array 396 of piston sleeve inserts 399. The pressurized liquid introduced forces the piston to the right as viewed in FIG. 16.

Pressurized fluid incrementally passing through vertical inlet passage 165 also simultaneously incrementally passes from the vertical inlet through L shape inlet passage 415, port 416 in the upper portion of valve sleeve 12, angled passage 435 in the valve body, port 440 in the lower portion of valve sleeve 12, and left L shape passage 445 into the left manifold passage 446. The liquid from manifold passage 446 incrementally passes into the left end of each of the bores 409 of the circumferentially arrayed left piston sleeve inserts 399. The pressurized liquid introduced forces the left micro piston rods 394 to the right as viewed in FIG. 14, while maintaining the filled liquid state of each of the bores 409 left of the ends of needle piston rods 394 during the piston stroke.

As the piston 262 moves to the right in FIG. 16, the liquid between the piston and the right piston sleeve inserts 400 is incrementally returned to reservoir 84 while the liquid in the bores 410 to the right of the micro piston rods 395 is delivered in incremental movements to the mixing and dispensing station. With respect to the liquid to the right of the piston and to the left of the right array 397 of piston sleeve inserts, it is forced sequentially and incrementally through vertical passage 448, port 442 in the lower portion of the valve sleeve 12, angled valve body passage 437, port 427 in the upper portion of the valve sleeve, and return passage 426C. Liquid leaving the top block 2 via vertical passage 426C incrementally passes through return line 110 back to reservoir 84. With respect to the liquid to the right of needle piston rods 395, it collectively incrementally passes through right manifold passage 450, right L shape passage 449, port 443 in the lower portion of the valve sleeve, angled passage 438 in the valve body, port 421 in the upper portion of the valve sleeve, and delivery line 422C to the top surface of top block 2. Liquid dispensed from the vertical passage 422C passes in incremental movements through delivery line 98 to a mixing and dispensing station. The pressure of the liquid in delivery line 98 is continuously monitored by pressure sensor 100.

As will be appreciated by the description of the operation of the micro metering device of FIG. 16, the collective area of the ends of the micro piston rods 395 is considerably smaller than the area of the right side of piston 262. Accordingly, the pressure of the liquid driving the piston to the right as viewed in FIG. 16 can be considerably less than the pressure level normally used. As discussed above, the diameter of the bores in the piston sleeve inserts may be changed and/or the number of bores can be reduced or increased by capping some of the bores or adding extra sleeve inserts. Similarly, the software can be readily modified to change and tightly control the length of the piston stroke and thus the length of the stroke of the needle piston rods. As discussed in more detail above and below, the microprocessor in the closed loop system compares the parameter signals to the specification tolerances to keep all of the parameters as close to their mean values as possible and certainly well within the specification tolerances to continuously maintain the quality of the liquid product dispensed.

Referring to FIGS. 12, 13, 14 and 16, to replace the arrays of piston sleeve inserts or the piston rod sleeve, any vertical elongated bolt 379 connecting the top and middle blocks 2 and 3 to bottom left block 235 are removed. The left elongated bolts 385 connecting the left sleeve insert manifold to the left end block 235 and center base block 234 are also removed. The right end of the piston rod 277 is disconnected from vertical retention member 216 after removing right end cap 383. These steps allow the left end cap 382, left manifold 380, left base block 235, piston 262, and all of the piston rods and needle piston rods to be removed by axially sliding the same to the left. This exposes the left array of micro piston sleeve inserts for selective removal and replacement of the piston, piston sleeve inserts and/or micro piston rods as well as to expose the cylinder to access. Cylinder access allows the diameter of the piston sleeve to be changed if left and right base end blocks as shown in the embodiment of FIGS. 8 through 11 are being used. To change the right micro piston sleeve inserts with the connection between right piston rod 277 and vertical monitoring member 216 disconnected, any vertical elongated bolts 379 extending through top and middle blocks 2 and 3 into right end block 236 must be removed. The right elongated horizontal bolts 386 must also be removed to separate the right end cap, right manifold 381 and right end block 236 from the center block 234 in order to gain access to the right array 397 of micro piston sleeve inserts 400 for removal and replacement.

By using conventional tools, the sleeve inserts can be changed to have the desired configuration and bore size at each end of the enclosed cylinder 407 and the needle piston rods can be changed to complementary diameters and array configurations. The reconstituted micro metering device is then reassembled by reconnecting the parts together in the reverse order. The disassembly steps described can also be selectively used to replace any malfunctioning piston sleeve insert or needle piston rod. It will be appreciated that disassembly can also be started on the right side as well following the same general disassembly steps in a mirrored approach.

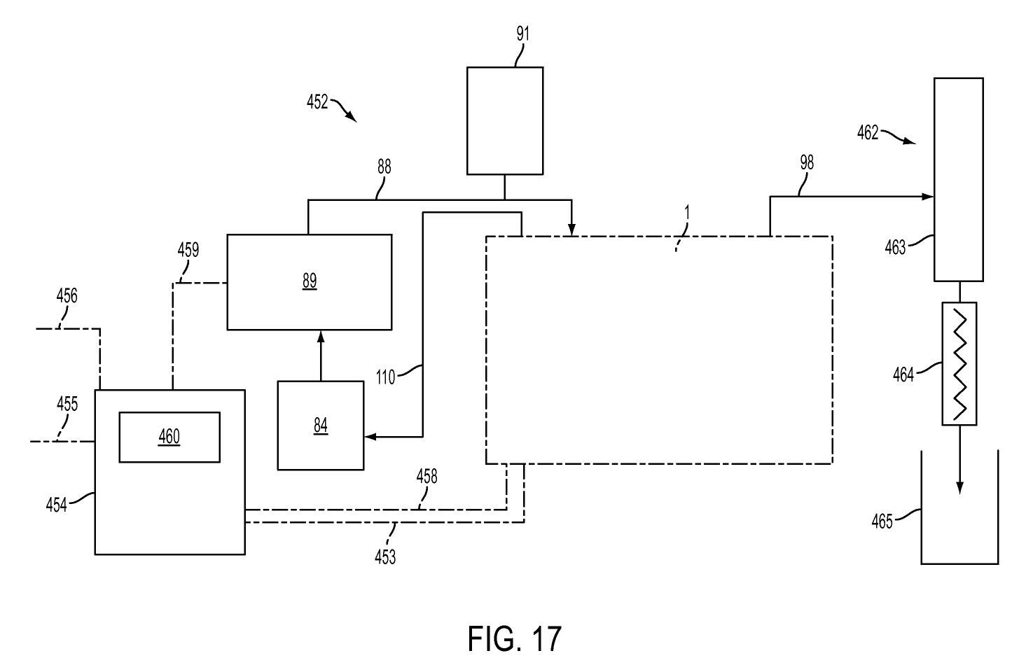

Turning now to FIGS. 17 through 19, the overall meter device control and dispensing system is illustrated for a single meter as well as for multiple meters in combined systems. With respect to FIG. 17, a single meter device system, indicated generally at 452, is disclosed. The single meter device 1 illustrated in schematic block form can be any of the embodiments or combination of embodiments disclosed above. The configuration for the metering device 1 is chosen for the liquid being processed. As discussed above, the metering device is continuously monitoring numerous parameters including inlet liquid pressure and temperature, the speed, direction and position of the servo motor rotating the valve body, the speed, direction and position of the piston, and the outlet pressure of the liquid being dispensed. Signals representing the continuously monitored parameter data are continuously transmitted by output line 453 to a central microprocessor or programmable logic controller (PLC) in the master control panel (MCP) 454. The MCP is powered, by way of example only, by 220 VAC input line 455 and is connected to Ethernet communication bus 456.

The input data to MCP 454 is continuously compared by the microprocessor or PLC to the tolerance specifications for each parameter. If the continuously monitored data for any parameter begins to vary from the mean value, the software in the processor makes adjustments on the fly to keep the data at or near the mean value and well within the specification tolerances for that parameter. The software adjustments result in revised input signals across the input line 458 to control the motor speed for valve body rotation and/or across the input line 459 to control the motor speed of pump 89. By controlling the motor speed of the valve body motor, the speed and position of the piston are controlled for the characteristics of the pressurized liquid being processed to make sure the piston stroke is repeatedly of equal length over identical time periods. By controlling pump motor speed based on operating parameters, the pressure of the liquid withdrawn from the reservoir is controlled to be within specifications as it passes through the inlet delivery line 88 to the metering device 1. If continuous closed loop control fails to output liquid within the specifications, a warning signal is generated to shut off the metering device or devices to allow maintenance to correct leaks, clogged filters or other system problems.

An accumulator 91 is positioned in the inlet delivery line 88 to minimize pressure spikes in the line. The MCP 454 has a display 460 to allow the system operator to continuously monitor system performance for each of the parameters and to manually make adjustments, if necessary. The display may also provide data on the performance of the seal assemblies and indicate how many more cycles can be run before routine maintenance should be performed. Finally the display will provide warnings in the case of equipment malfunctions to allow the system to be promptly turned off if not already automatically shut off.

The flush return system with return line 110 to the reservoir 84 is operative for multiple purposes depending upon the embodiment or combination of embodiments. For example, the flush return system protects the seal assembly cartridges from pressurized liquid weepage, assists in providing some controlled turbulence in the pressurized liquid in the piston cylinder assembly and/or returns liquid from the cylinder in the micro metering system.

The metered liquid shot from the metering device 1 is dispensed through the outlet dispensing line 98 to a mixing and dispensing station, indicated generally at 462. This mixing and dispensing station may have many different structural components and characteristics depending upon the material being dispensed. For example the mixing and dispensing station head may have a hopper 463, which may include a static or dynamic mixer therein to initially treat the liquid. The mixing and dispensing station may then have another dynamic or static auger mixer 464 in series with the first to finally agitate the liquid before it is dispensed into the shipping container 465. Depending upon the liquid being dispensed, the liquid may pass through the outlet dispensing line 98 directly into the shipping container 465. The hopper should have sufficient volume to hold metered liquid so that shipping containers 465 can be cycled through the system without discontinuing or slowing down the metering device 1.

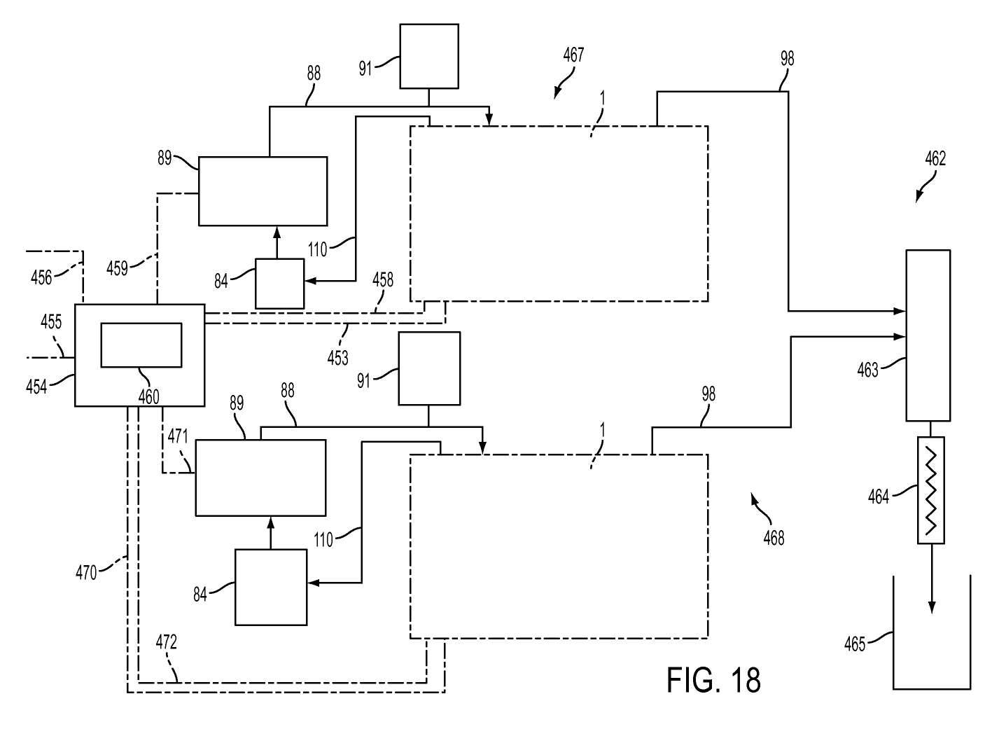

Turning now to FIG. 18, two metering devices 1 are included in a composite system to allow accurate metered amounts of two different liquids to be mixed for the ultimate liquid product shipped. The characteristics and relative amounts of the two liquids being metered assist in determining the types of metering device embodiments to be used in the composite system. For example, the first metering device may be the embodiment shown in FIGS. 8 through 11 with the sleeve and piston size picked to be in conformance with the throughput specifications for a given liquid with specific operating parameters. The second metering device may be the micro metering device embodiment disclosed in FIGS. 12 through 16 for a limited volume of a second liquid to be dispensed and mixed with the first liquid. In the composite two metering device system, many of the components are the same as the components of the first system of FIG. 17 and thus the same numbers will be used and only the differences between the systems will be described.

In the composite two meter device system, the microprocessor in the MCP controls the first meter device system, indicated generally at 467, as the master system. The second meter device system in the multi meter system of FIG. 2, indicated generally at 468, is a slave to the first meter device system and is synchronized with the operation of the first meter system. To that end, the first master meter device system 467 will have a piston stroke of a given length over a fixed time period. The microprocessor in the MCP 454 will receive parameter input signals on input line 470 from the slave metering device system 468. These input signals represent the continuously monitored data on the operating parameters of the second slave system. The microprocessor in MCP 454 outputs control signals over output line 471 to control pump 89 and output line 472 to the motor rotating the valve body in the slave system. These output signals are determined by the microprocessor to keep the operating parameters of the slave system 468 within specification tolerances for the liquid being processed as well as to synchronize the slave system to the first master system. For example, while the stroke for the second piston may be shorter than the stroke for the first piston given the different liquids, the time over which the two strokes occurs will be synchronized to be identical.

Thus when the first and second liquid shots from the first and second metering devices are delivered to the mixing and dispensing station 462 through outlet dispensing lines 98, the timing of the dispensing will be synchronized to be the same for both liquid shots to have better and more consistent mixing in the mixing and dispensing head throughout the repetitive cycles. By controlling the parameters of both the master and slave systems to be within specification tolerances and by synchronizing the two metering devices in a predetermined ratio, a more consistent quality end product is obtained with higher rates of production and less downtime.

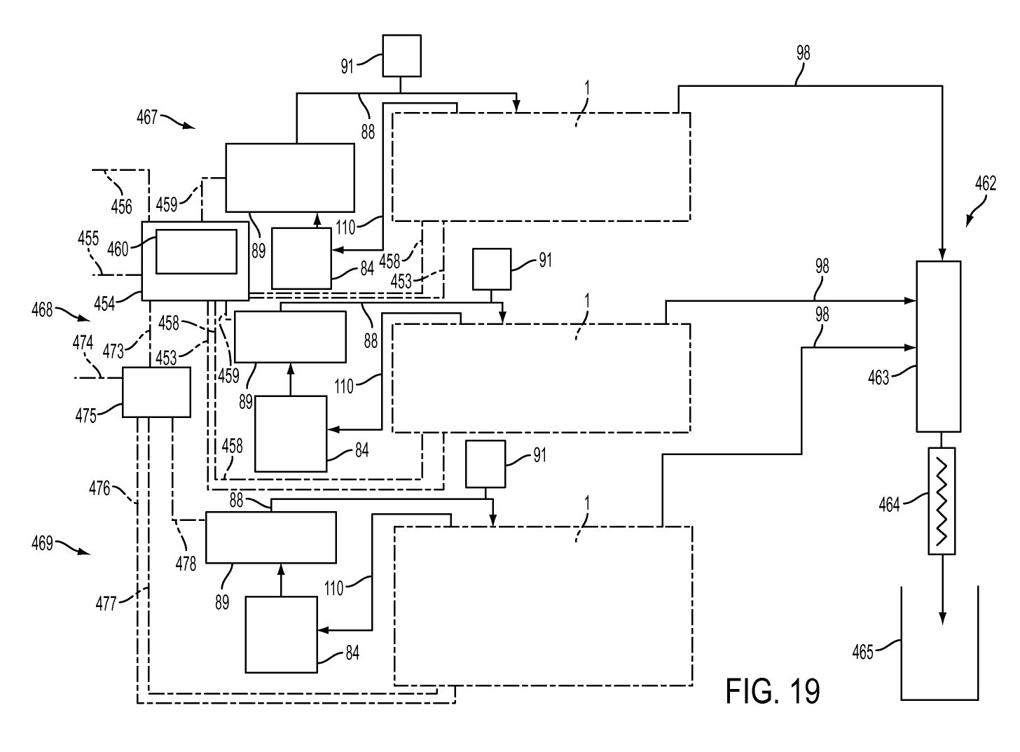

Turning now to FIG. 19, a composite metering system is provided that includes three metering devices normally used for processing and ultimately mixing three different liquids. In this composite system, the first system 467 with the first metering device is the master meter and the second and third systems 468 and 469 with the second and third metering devices are first and second slaves to that first master system to provide synchronization of all three systems. The master control panel and microprocessor can be enlarged in size and capacity to control the master and two slave devices. Alternatively, to keep a reasonable size for master control panel 464 and to maintain synchronization, the master control panel only directly controls the master and the first slave device in the composite system.

An input-output synchronization bus 473 extends between the MCP 454 and an add on microprocessor box 475 for the second slave metering device. The add on microprocessor box 475 has, by way of example only, a 220 volt power input line 474. A third slave metering device may also be added to and controlled through the add on microprocessor box 475. The input signal line 476 for the second slave metering device extends between the device 1 and the add on microprocessor box 475. The add on microprocessor box 475 compares the various parameter signals received from the metering device and compares them to the specification tolerances as discussed in more detail above. When the add on microprocessor detects a parameter straying from its mean value, software adjustments are made to keep the parameter at or near the mean value and well within specification tolerances. These software adjustments result in output signals to control the pump and valve motor to maintain system compliance in the second slave system 469. Specifically, output line 478 from the add on processor box 475 to pump 89 adjusts pump speed in accordance with the software adjustments. Output line 477 from the processor box 475 to the valve motor adjusts motor speed or direction for the second slave system 469 in accordance with the software adjustment. The timing for the piston strokes in the second slave system is synchronized with the piston stroke timing of the master piston through input output synchronization bus 473. The dispensed liquid from the second slave dispensing system 469 is delivered by line 98 to the mixing and dispensing station 462 for mixing with the other two liquids. The mixture of the three liquids is then dispensed into the shipping container 465. Different liquids metered in a single meter device or in a multiple meter device system may include almost all liquid products dispensed alone or in combination including, by way of example only, paints, petroleum products, adhesives and beverages.

As discussed above, the specific metering device embodiment or combination of embodiments used as the master is based upon the liquid being processed, its operating parameters and the volume of liquid required during each stroke. Similarly, the two slave metering devices are selected based upon the same criteria and operate in a predetermined ratio to the master metering device. This ratio may be varied depending upon materials being processed and formulas being used for any given application of the system. These composite metering device systems can be enlarged by adding on additional micro processor boxes to handle two slave metering devices per box, with synchronization being obtained based on the master metering device. Alternatively, the MCP and microprocessor can be enlarged to control the master and all slave devices.

While the present invention has been illustrated by the figures and by the description of embodiments thereof, and while the embodiments have been described in considerable detail, it is not the intention of the applicants to restrict or in any way limit the scope of the appended claims to such detail. For example, the changeable piston sleeve and piston diameter embodiment shown in detail in FIGS. 8, 9, and 11 could be used in all embodiments. Similarly, the piston without piston rods of the first embodiment could be used in other embodiments. In addition, the invention is not limited to the specific configurations of passages, ports and connections disclosed herein. Therefore, the invention, in its broader aspects, is not limited to the specific details, the representative apparatus and illustrative examples shown and described. Accordingly, departures can be made from such details without departing from the scope or spirit of applicants' inventive concept.

1. A metering system for dispensing material comprising:
a first metering device having components including;
a source of material,
a movable valve assembly for selectively directing the material,
a piston cylinder assembly,
passages containing material incrementally moving therethrough and connecting the source to the valve, connecting the valve to and from the piston cylinder assembly, and connecting the valve outlet to a dispensing passage,
sensors for continuously detecting parameters relating to any or all of valve motion, piston motion and material characteristics, and
a system microprocessor continuously receiving feedback parameter signals from the sensors of the first metering device and comparing the feedback parameters to comparable desired parameter specifications to allow changes to be implemented in real time to correct any variance from a mean value for those specifications in the material being processed to meet the desired specifications.

2. The metering system of claim 1 wherein any combination or all of the parameters are used as feedback signals to the system microprocessor.

3. The metering system of claim 2 wherein the first metering device further includes a pump to pressurize the material before entering the movable valve assembly and a drive to control movement of the valve to alternate delivery of pressurized material from one side of the piston to the other.

4. The metering system of claim 3 wherein the system microprocessor utilizes a continuous closed signal loop to direct control signals based upon the system microprocessor comparison to at least one of the pump and valve drive to vary in real time their operation to deliver pressurized material to an outlet dispensing passage meeting quality specifications.

5. The metering system of claim 4 wherein the control signals are directed to both the valve drive and pump to meet the desired specifications.

6. The metering system of claim 3 wherein a warning signal is generated to shut off the metering device if the material being output is outside the specifications.

7. The metering system of claim 4 wherein the outlet dispensing passage directs material to a system dispensing station.

8. The metering system of claim 7 wherein the system dispensing station includes a mixer to agitate the material for dispensing into a shipping container.

9. The metering system of claim 8 wherein the mixer includes a hopper with a dynamic auger.

10. The metering system of claim 9 wherein the mixer includes a hopper with a static auger.

11. The metering system of claim 8 wherein a second mixer is in series with the mixer to further agitate the material before dispensing into the shipping container.

12. The metering system of claim 3 further including a second metering device having the same components as the first metering device where the continuously sensed parameters of the second metering device are continuously fed back as signals to the system microprocessor for comparison to the specifications and control signals based upon that comparison are continuously directed to at least one of the pump and valve drive in the second metering device to keep the output material within specifications.

13. The metering system of claim 12 wherein the control signals are directed to both the valve drive and pump to meet the desired specifications.

14. The metering system of claim 12 wherein the first metering system is a master and the second metering system is a slave and material dispensing from the second metering system is synchronized with material dispensed from the first metering system by the system microprocessor common to both the first and second metering devices.

15. The metering system of claim 14 wherein real time pump or drive changes can be made to one or both of the metering devices by continuous closed loop signals to and from the system microprocessor to maintain synchronous dispensing from both metering devices of material in desired quantities and ratios meeting manufacturing specifications.

16. The metering system of claim 15 wherein the material in the first metering device is a first liquid and the material in the second metering device is a second different liquid mixed in variably controlled ratios for any specific application.

17. The metering system of claim 16 wherein synchronization of the first and second metering devices includes a quantity dispensing ratio between the first and second liquids that may be varied depending upon conditions or liquids being dispensed.

18. The metering system of claim 16 wherein the first and second liquids are delivered to the system dispensing station for mixing.

19. The metering system of claim 12 wherein additional slave metering devices having the same components as the first metering device may be added to the first and second metering devices and connected to the system microprocessor by an input output synchronization bus.

20. The metering system of claim 19 wherein dispensing materials in quantities and ratios desired from each of the additional slave metering devices is synchronized based upon the first metering device as the master.

21. The metering system of claim 20 wherein additional microprocessor boxes may be used in the input output bus to support additional slave metering devices.

22. A metering device for dispensing a material comprising:
a piston cylinder assembly for dispensing a metered amount of material with each stroke;
a sensor continuously monitoring speed and position of said piston and continuously outputting a feedback signal representative thereof to a microprocessor in a closed loop system, the microprocessor compares said position and speed feedback signal against specifications to direct a control signal back to continuously control the speed and position of the piston based upon the feedback signal, to dispense a metered amount of material within acceptable quality tolerances.

23. The metering device of claim 22 wherein the control signal is directed to a pump to assist delivery of pressurized material to said piston, a second sensor monitoring said material pressure and continuously outputting a feedback signal representative thereof to said microprocessor to compare the pressure feedback signal against pressure specifications and to direct a control signal back to said pump to continuously control the material pressure within specifications.

24. The metering device of claim 23 further including a movable valve operative alternately to deliver pressurized material to first and second sides of said piston and alternately to incrementally output metered amounts of material from the side of the piston not receiving pressurized material.

25. The metering device of claim 24 further comprising a sensor to monitor the valve and direct feedback signals to the microprocessor.

26. The metering device of claim 22 wherein the feedback and control signals also control a valve drive to control piston speed, position and direction.

27. The metering device of claim 26 wherein the control signals from the microprocessor are directed to both the valve drive and pump to meet the desired specifications.

28. The metering device of claim 26 wherein the speed of valve movement is varied to variably control the rate of opening and closing of valve ports.

29. The metering device of claim 28 wherein said valve speed is controlled to slowly open and close first and second valve ports.

30. The metering device of claim 29 wherein the valve rotates and oscillates between first and second positions at variable speeds controlled by the feedback and control signals.

31. The metering device a claim 30 wherein the valve is a linear reciprocal valve.

32. The metering device of claim 26 wherein additional sensors monitor other characteristics of the metering device and output other feedback signals representative of those characteristics to the microprocessor for comparing the characteristics of those other feedback signals against specifications to direct control signals back to the pump and/or valve drive for controlling material characteristics and the speed, position and direction of the piston and valve in accordance with the specifications.

33. The metering device of claim 32 wherein the other sensors include sensors to continuously monitor pressure and temperature magnitudes of pressurized material entering the valve and pressure magnitudes of metered material dispensed from the valve.

34. The metering device of claim 32 wherein a magnet is associated with said piston and cooperates with an encoder to generate the piston feedback signal.

35. The metering device of claim 33 wherein the piston carries the magnet.

36-104. (canceled)
